(19) United States
(12) Patent Application Publication
(10) Pub. No.: US 2026/0358607 A1
(43) Pub. Date: Nov. 12, 2026

(54) VARIABLE MAGNIFICATION OPTICAL SYSTEM, OPTICAL INSTRUMENT, AND METHOD FOR MANUFACTURING VARIABLE MAGNIFICATION OPTICAL SYSTEM

(71) Applicant: NIKON CORPORATION, Shinagawa-ku, Tokyo (JP)

(72) Inventors: Kyoya TOKUNAGA, Yokohama-shi (JP); Tomoyuki SASHIMA, Yokohama-shi (JP)

(21) Appl. No.: 19/136,726

(22) PCT Filed: Dec. 11, 2023
(86) PCT No.: PCT/JP2023/044218

§ 371 Date: Dec. 9, 2025

(30) Foreign Application Priority Data
Dec. 9, 2022 (JP) 2022-197186

(51) Int. Cl. G02B 15/14; G02B 13/02

(52) U.S. Cl. CPC G02B 15/1461; G02B 13/02

(57) ABSTRACT

A zoom optical system (ZL) comprises a first lens group (G1) having positive refractive power, a second lens group (G2) having negative refractive power, a third lens group (G3) having positive refractive power, and a rear group (GR), wherein when zooming from a wide-angle end state (W) to a first telephoto end state (T1), a distance between each adjacent lens group changes, the first lens group (G1) is fixed relative to an image surface I, and N1 lens groups move along the optical axis, N1 being 3 or higher, when zooming from the first telephoto end state (T1) to a second telephoto end state (T2), the first lens group G1 is fixed relative to the image surface I, and N2 lens groups move along the optical axis, N2 being lower than N1.

### TECHNICAL FIELD

The present invention relates to a zoom optical system, an optical device, and a method of manufacturing the zoom optical system.

### TECHNICAL BACKGROUND

Conventionally, a zoom optical system suitable for a photographic camera, an electronic still camera, a video camera, and the like has been proposed (for example, see Patent Literature 1). In such a zoom optical system, it is difficult to obtain bright and favorable optical performance while being compact.

### PRIOR ARTS LIST

### Patent Document

Patent literature 1: Japanese Laid-Open Patent Publication No. 2020-52338 (A)

### SUMMARY OF THE INVENTION

A zoom optical system according to a first aspect of the present invention comprises, in order from an object along an optical axis, a first lens group having positive refractive power, a second lens group having negative refractive power, a third lens group having positive refractive power, and a rear group, wherein zooming from a wide-angle end state to a first telephoto end state, a distance between each adjacent lens group changes, the first lens group is fixed relative to an image surface, and N1 lens groups move along the optical axis, when zooming from the first telephoto end state to a second telephoto end state, the first lens group is fixed relative to the image surface, and N2 lens groups move along the optical axis, N1 is an integer of 3 or higher and N2 is a positive integer lower than N1, and the following conditional expressions are satisfied.

0.10<MB/MA<2.00

ft1/ft2<0.95
Where MA: a movement amount of a lens group with the largest movement amount when zooming from the wide-angle end state to the first telephoto end state,
MB: a movement amount of the lens group with the largest movement amount when zooming from the first telephoto end state to the second telephoto end state,
ft1: a focal length of the zoom optical system in the first telephoto end state, and
ft2: a focal length of the zoom optical system in the second telephoto end state.

A zoom optical system according to a second aspect of the present invention comprises, in order from an object along an optical axis, a first lens group having positive refractive power, a second lens group having negative refractive power, a third lens group having positive refractive power, and a rear group, wherein when zooming from a wide-angle end state to a first telephoto end state, a distance between each adjacent lens group changes, the first lens group is fixed relative to an image surface, and the second lens group moves along the optical axis, when zooming from the first telephoto end state to a second telephoto end state, the first lens group and the second lens group are fixed relative to the image surface, and at least part of the rear group moves along the optical axis, and the following conditional expressions are satisfied.

0.75<MG2/(−f2)<1.30

ft1/ft2<0.95
Where f2: a focal length of the second lens group,
MG2: a movement amount of the second lens group when zooming from the wide-angle end state to the first telephoto end state,
ft1: a focal length of the zoom optical system in the first telephoto end state, and
ft2: a focal length of the zoom optical system in the second telephoto end state.

An optical device according to the present invention includes the above zoom optical system.

A method of manufacturing a zoom optical system according to a first aspect of the present invention comprising, in order from an object along an optical axis, a first lens group having positive refractive power, a second lens group having negative refractive power, a third lens group having positive refractive power, and a rear group, wherein when zooming from a wide-angle end state to a first telephoto end state, a distance between each adjacent lens group changes, the first lens group is fixed relative to an image surface, and N1 lens groups move along the optical axis, when zooming from the first telephoto end state to a second telephoto end state, the first lens group is fixed relative to the image surface, and N2 lens groups move along the optical axis. N1 is an integer of 3 or higher and N2 is a positive integer lower than N1, and the method of manufacturing the zoom optical system includes arranging each lens in a lens barrel so as to satisfy the following conditional expressions.

0.10<MB/MA<2.00

ft1/ft2<0.95
Where MA: a movement amount of a lens group with the largest movement amount when zooming from the wide-angle end state to the first telephoto end state,
MB: a movement amount of the lens group with the largest movement amount when zooming from the first telephoto end state to the second telephoto end state,
ft1: a focal length of the zoom optical system in the first telephoto end state, and
ft2: a focal length of the zoom optical system in the second telephoto end state.

A method of manufacturing a zoom optical system according to a second aspect of the present invention comprising, in order from an object along an optical axis, a first lens group having positive refractive power, a second lens group having negative refractive power, a third lens group having positive refractive power, and a rear group, wherein when zooming from a wide-angle end state to a first telephoto end state, a distance between each adjacent lens group changes, the first lens group is fixed relative to an image surface, and the second lens group moves along the optical axis, when zooming from the first telephoto end state to a second telephoto end state, the first lens group and the second lens group are fixed relative to the image surface, and at least part of the rear group moves along the optical axis, and the method of manufacturing the zoom optical system includes arranging each lens in a lens barrel so as to satisfy the following conditional expressions.

0.75<MG2/(−f2)<1.30

ft1/ft2<0.95
Where f2: a focal length of the second lens group,
MG2: a movement amount of the second lens group when zooming from the wide-angle end state to the first telephoto end state,
ft1: a focal length of the zoom optical system in the first telephoto end state, and
ft2: a focal length of the zoom optical system in the second telephoto end state.

An optical system according to a third aspect of the present invention includes a lens group for zooming that moves in an optical axis direction when zooming from a wide-angle end state to a first telephoto end state, and a lens group for focusing that moves in the optical axis direction when zooming from the wide-angle end state to the first telephoto end state and moves in the optical axis direction for focusing, wherein the lens group for focusing is moved in the optical axis direction and the first telephoto state is switched to a second telephoto state having a higher magnification, while the lens group for zooming remains fixed in the optical axis direction.

### BRIEF DESCRIPTION OF THE DRAWINGS

FIG. 1 is a diagram showing a lens configuration of a zoom optical system according to a first example;

FIG. 2 is a schematic diagram showing a lens position control mechanism according to the first example;

FIG. 3 illustrates graphs showing various aberrations upon focusing on infinity in a wide-angle end state of the zoom optical system according to the first example;

FIG. 4 illustrates graphs showing various aberrations upon focusing on infinity in a first telephoto end state of the zoom optical system according to the first example;

FIG. 5 illustrates graphs showing various aberrations upon focusing on infinity in a second telephoto end state of the zoom optical system according to the first example;

FIG. 6 is a diagram showing a lens configuration of a zoom optical system according to a second example;

FIG. 7 is a schematic diagram showing a lens position control mechanism according to the second example;

FIG. 8 illustrates graphs showing various aberrations upon focusing on infinity in a wide-angle end state of the zoom optical system according to the second example;

FIG. 9 illustrates graphs showing various aberrations upon focusing on infinity in a first telephoto end state of the zoom optical system according to the second example;

FIG. 10 illustrates graphs showing various aberrations upon focusing on infinity in a second telephoto end state of the zoom optical system according to the second example;

FIG. 11 is a diagram showing a lens configuration of a zoom optical system according to a third example;

FIG. 12 is a schematic diagram showing a lens position control mechanism according to the third example;

FIG. 13 illustrates graphs showing various aberrations upon focusing on infinity in a wide-angle end state of the zoom optical system according to the third example;

FIG. 14 illustrates graphs showing various aberrations upon focusing on infinity in a first telephoto end state of the zoom optical system according to the third example;

FIG. 15 illustrates graphs showing various aberrations upon focusing on infinity in a second telephoto end state of the zoom optical system according to the third example;

FIG. 16 is a diagram showing a configuration of a camera including a zoom optical system according to each embodiment;

FIG. 17 is a flowchart showing a method of manufacturing the zoom optical system according to a first embodiment; and

FIG. 18 is a flowchart showing a method of manufacturing the zoom optical system according to a second embodiment.

### DESCRIPTION OF THE EMBODIMENTS

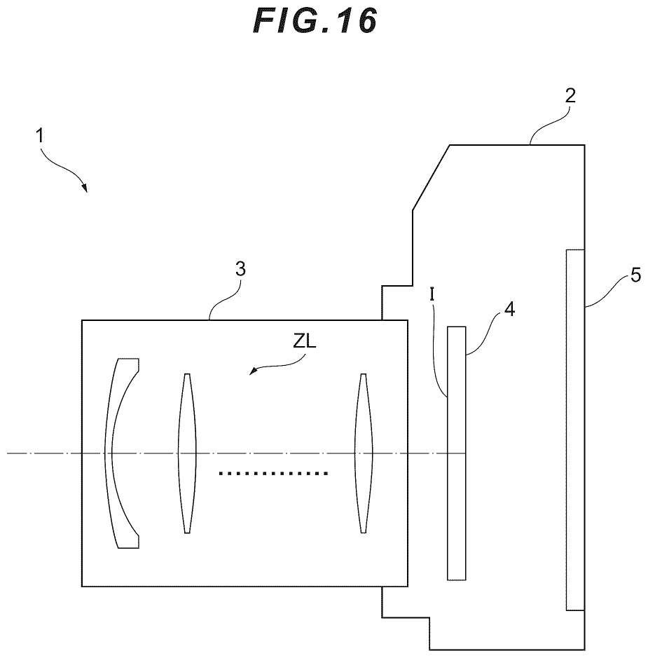

Hereinafter, preferred embodiments according to the present invention will be described. First, a camera (optical device) including a zoom optical system according to each embodiment will be described with reference to FIG. 16. As shown in FIG. 16, this camera 1 includes a main body 2 and a photographic lens 3 that is attached to the main body 2. The main body 2 includes an imaging element 4, a main body control part (not shown) that controls an operation of a digital camera, and a liquid crystal screen 5. The photographic lens 3 includes a zoom optical system ZL comprising a plurality of lens groups, and a lens position control mechanism (not shown) that controls a position of each lens group.

Light from a subject is collected by the zoom optical system ZL of the photographic lens 3 and reaches an image surface I of the imaging element 4. The light from the subject that has reached the image surface I is photoelectrically converted by the imaging element 4 and recorded as digital image data on a memory (not shown). The digital image data recorded on the memory can be displayed on the liquid crystal screen 5 in response to an operation by a user. Note that this camera can be a mirrorless camera or a single-lens reflex camera including a quick-return mirror. The zoom optical system ZL shown in FIG. 16 is a schematic representation of the zoom optical system included in the photographic lens 3, and a lens configuration of the zoom optical system ZL is not limited to this configuration.

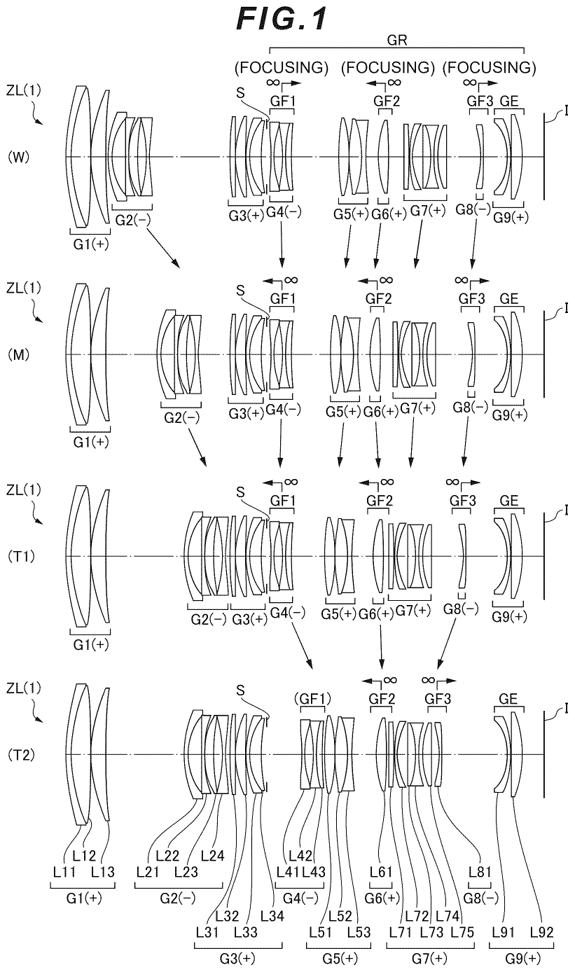

Next, the zoom optical system according to the first embodiment will be described. As shown in FIG. 1, the zoom optical system ZL(1) as an example of the zoom optical system (zoom lens) ZL according to the first embodiment comprises, in order from an object along an optical axis, a first lens group G1 having positive refractive power, a second lens group G2 having negative refractive power, a third lens group G3 having positive refractive power, and a rear group GR including at least five lens groups. When zooming from a wide-angle end state (W) to a first telephoto end state (T1), a distance between each adjacent lens group changes, the first lens group G1 is fixed relative to the image surface I, and N1 lens groups move along the optical axis. When zooming from the first telephoto end state (T1) to a second telephoto end state (T2), the first lens group G1 is fixed relative to the image surface I, and N2 lens groups move along the optical axis. Here, N1 is an integer of 3 or higher and N2 is a positive integer lower than N1.

Based on the above configuration, the zoom optical system ZL according to the first embodiment satisfies the following conditional expression (1) and conditional expression (2).

0.10<MB/MA<2.00 (1)

ft1/ft2<0.95 (2)
Where MA: a movement amount of a lens group with the largest movement amount when zooming from the wide-angle end state to the first telephoto end state,
MB: a movement amount of the lens group with the largest movement amount when zooming from the first telephoto end state to the second telephoto end state,
ft1: a focal length of the zoom optical system ZL in the first telephoto end state, and
ft2: a focal length of the zoom optical system ZL in the second telephoto end state.

According to the first embodiment, it is possible to obtain a zoom optical system having bright and favorable optical performance while being compact, and an optical device including this zoom optical system. Note that a zooming ratio (telephoto magnification) in the second telephoto state is greater than a zooming ratio (telephoto magnification) in the first telephoto state. That is, it is possible to increase the telephoto magnification by switching from the first telephoto state to the second telephoto state. With this, an effect similar to using a teleconverter in a so-called lens interchangeable camera can be obtained. This also applies to second and third embodiments.

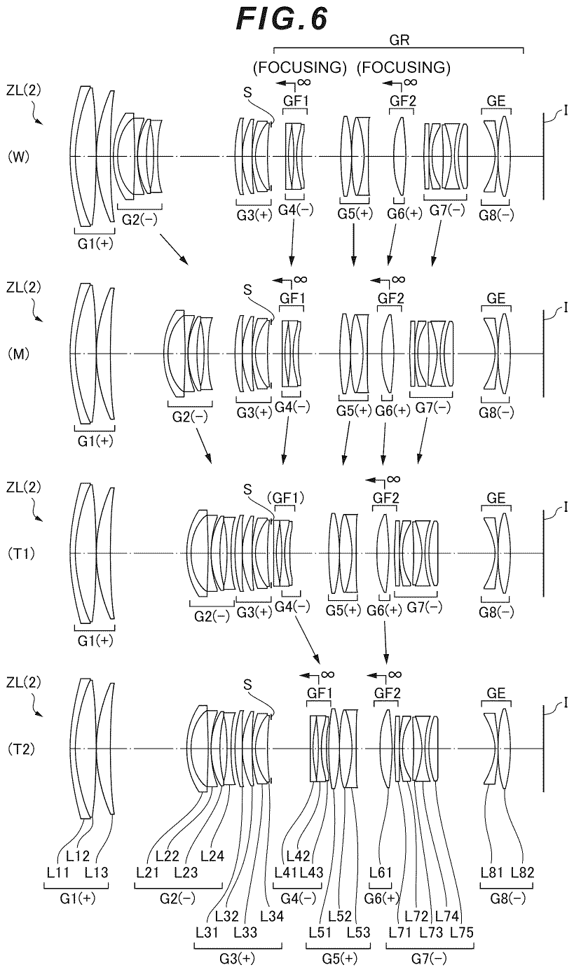

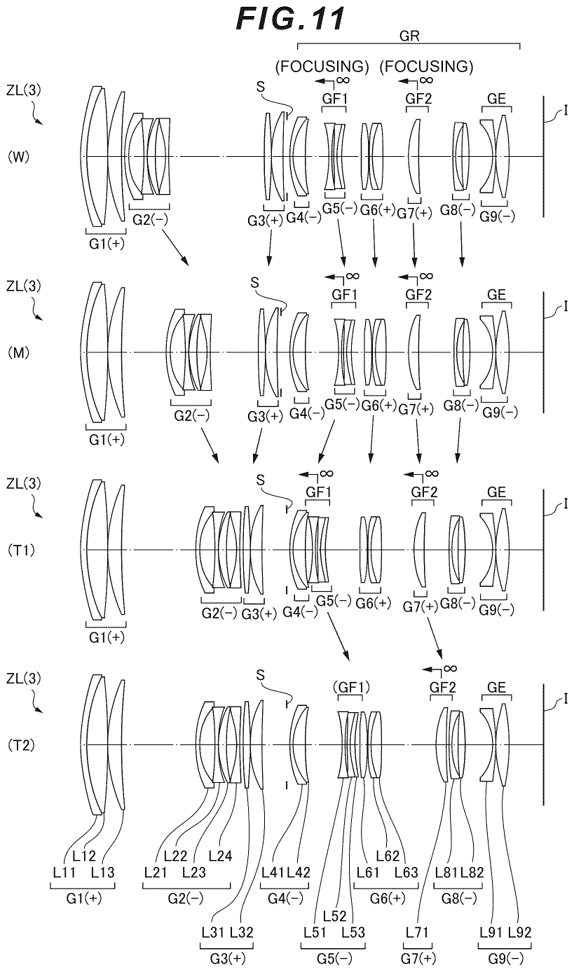

In zooming from the wide-angle end state (W) to the first telephoto end state (T1) via a medium focus state (M) a focal length of the entire optical system is continuously changed while forming an image on the same plane. That is, control is performed for zooming so that an appropriate focal length is achieved for any state from the wide-angle end state (W) to the first telephoto end state (T1). On the other hand, zooming (switching) from the first telephoto end state (T1) to the second telephoto end state (T2) does not require continuously changing the focal length, and as long as it is possible to form an image in focus at least in the first telephoto end state (T1) and the second telephoto end state (T2), image formation performance therebetween is not required. A so-called lens interchangeable camera is similar to attaching/detaching a teleconverter, and by attaching the teleconverter in the first telephoto end state (T1), the first telephoto end state (T1) becomes the second telephoto end state (T2). Therefore, zooming from the first telephoto end state (T1) to the second telephoto end state (T2) does not require continuous control like when zooming from the wide-angle end state (W) to the first telephoto end state (T1), and may be intermittent (discontinuous, discrete). As can be understood from the above description, according to the first embodiment, it is possible to increase the focal length from the first telephoto end state (T1) to the second telephoto end state (T2) without needing to attach a teleconverter while using the same optical system. These matters are not limited to the zoom optical system ZL according to the first embodiment, but are also applicable to a zoom optical system according to a second embodiment. Furthermore, the same applies to the zoom optical system ZL(1) as a first example shown in FIG. 1, a zoom optical system ZL(2) as a second example shown in FIG. 6, and a zoom optical system ZL(3) as a third example shown in FIG. 11.

The conditional expression (1) defines an appropriate relationship between the movement amount of the lens group with the largest movement amount when zooming from the first telephoto end state to the second telephoto end state, and the movement amount of the lens group with the largest movement amount when zooming from the wide-angle end state to the first telephoto end state. In each embodiment, the movement amount of the lens group when zooming from the wide-angle end state to the first telephoto end state indicates a difference (absolute value) between a position of the lens group on the optical axis in the first telephoto end state and a position of the lens group on the optical axis in the wide-angle end state. The movement amount of the lens group when zooming from the first telephoto end state to the second telephoto end state indicates a difference (absolute value) between a position of the lens group on the optical axis in the second telephoto end state and the position of the lens group on the optical axis in the first telephoto end state. By satisfying the conditional expression (1), spherical aberration, coma aberration, and curvature of field can be favorably corrected.

When a corresponding value of the conditional expression (1) exceeds an upper limit value, the movement amount of the lens group with the largest movement amount when zooming from the wide-angle end state to the first telephoto end state decreases, which complicates correcting spherical aberration, coma aberration, and curvature of field that occur in the lens group. By setting the upper limit value of the conditional expression (1) to 1.75, 1.50, 1.25, 1.00, 0.80, 0.65, or further 0.50, it is possible to more reliably achieve the effect of the first embodiment.

When the corresponding value of the conditional expression (1) falls below a lower limit value, the movement amount of the lens group with the largest movement amount when zooming from the first telephoto end state to the second telephoto end state decreases, which complicates correcting spherical aberration, coma aberration, and curvature of field that occur in the lens group. By setting the lower limit value of the conditional expression (1) to 0.10, 0.20, 0.30, or further 0.40, it is possible to more reliably achieve the effect of the first embodiment.

The conditional expression (2) defines an appropriate relationship between the focal length of the zoom optical system ZL in the first telephoto end state and the focal length of the zoom optical system ZL in the second telephoto end state. By satisfying the conditional expression (2), it is possible to obtain a zoom optical system having a high zooming ratio while being compact. By setting an upper limit value of the conditional expression (2) to 0.90, 0.85, 0.80, or further 0.75, it is possible to more reliably achieve the effect of the first embodiment. By setting a lower limit value of the conditional expression (2) to 0.45, 0.50, or further 0.60, it is possible to more reliably achieve the effect of the first embodiment.

In the zoom optical system ZL according to the first embodiment, the rear group GR includes N2 focus lens groups that move along the optical axis when focusing, and the N2 focus lens groups may move along the optical axis when zooming from the first telephoto end state to the second telephoto end state. Here, N2 is an integer of 2 or higher and lower than N1. With this, it is possible to obtain a zoom optical system having a high zooming ratio while being compact. Note that a lens group that moves when focusing in the wide-angle end state may be referred to as a focus lens group.

Next, the zoom optical system according to the second embodiment will be described. A zoom optical system ZL according to the second embodiment has a similar configuration to that of the zoom optical system ZL according to the first embodiment and therefore will be described with the same reference signs. As shown in FIG. 1, the zoom optical system ZL(1) as an example of the zoom optical system (zoom lens) ZL according to the second embodiment comprises, in order from the object along the optical axis, the first lens group G1 having positive refractive power, the second lens group G2 having negative refractive power, the third lens group G3 having positive refractive power, and the rear group GR. When zooming from the wide-angle end state (W) to the first telephoto end state (T1), the distance between each adjacent lens group changes, the first lens group G1 is fixed relative to the image surface I, and the second lens group G2 moves along the optical axis. When zooming from the first telephoto end state (T1) to the second telephoto end state (T2), the first lens group G1 and the second lens group G2 are fixed relative to the image surface I, and at least part of the rear group GR moves along the optical axis.

Based on the above configuration, the zoom optical system

ZL according to the second embodiment satisfies the following conditional expression (3) and conditional expression (2).

0.75<MG2/(−f2)<1.30 (3)

ft1/ft2<0.95 (2)
Where f2: a focal length of the second lens group G2,
MG2: a movement amount of the second lens group G2 when zooming from the wide-angle end state to the first telephoto end state,
ft1: the focal length of the zoom optical system ZL in the first telephoto end state, and
ft2: the focal length of the zoom optical system ZL in the second telephoto end state.

According to the second embodiment, it is possible to obtain a zoom optical system having bright and favorable optical performance while being compact, and an optical device including this zoom optical system.

Similar to the first embodiment, in zooming from the wide-angle end state (W) to the first telephoto end state (T1) via the medium focus state (M), control is performed for zooming so that an appropriate focal length is achieved for any state from the wide-angle end state (W) to the first telephoto end state (T1). On the other hand, in zooming (switching) from the first telephoto end state (T1) to the second telephoto end state (T2), a so-called lens interchangeable camera is similar to attaching/detaching a teleconverter, and continuous control like when zooming from the wide-angle end state (W) to the first telephoto end state (T1) is not required and may be intermittent (discontinuous, discrete). Also in the second embodiment, it is possible to increase the focal length from the first telephoto end state (T1) to the second telephoto end state (T2) without needing to attach a teleconverter while using the same optical system.

The conditional expression (3) defines an appropriate relationship between the movement amount of the second lens group G2 when zooming from the wide-angle end state to the first telephoto end state, and the focal length of the second lens group G2. By satisfying the conditional expression (3), spherical aberration, coma aberration, and curvature of field can be favorably corrected.

When a corresponding value of the conditional expression (3) exceeds an upper limit value, the refractive power of the second lens group G2 increases, which complicates correcting spherical aberration, coma aberration, and curvature of field that occur in the second lens group G2. By setting the upper limit value of the conditional expression (3) to 1.20 or further 1.10, it is possible to more reliably achieve the effect of the second embodiment.

When the corresponding value of the conditional expression (3) falls below a lower limit value, the movement amount of the second lens group G2 when zooming from the wide-angle end state to the first telephoto end state decreases, which complicates correcting spherical aberration, coma aberration, and curvature of field that occur in the second lens group G2. By setting the lower limit value of the conditional expression (3) to 0.80 or further 0.85, it is possible to more reliably achieve the effect of the second embodiment.

As described above, the conditional expression (2) defines the appropriate relationship between the focal length of the zoom optical system ZL in the first telephoto end state and the focal length of the zoom optical system ZL in the second telephoto end state. By satisfying the conditional expression (2), it is possible to obtain a zoom optical system having a high zooming ratio while being compact. By setting the upper limit value of the conditional expression (2) to 0.90, 0.85, 0.80, or further 0.75, it is possible to more reliably achieve the effect of the second embodiment. By setting the lower limit value of the conditional expression (2) to 0.45, 0.50, or further 0.60, it is possible to more reliably achieve the effect of the second embodiment.

In the zoom optical system ZL according to the second embodiment, the rear group GR includes at least two focus lens groups that move along the optical axis when focusing, and the at least two focus lens groups may move along the optical axis when zooming from the first telephoto end state to the second telephoto end state. With this, it is possible to obtain a zoom optical system having a high zooming ratio while being compact. Note that a lens group that moves when focusing in the wide-angle end state may be referred to as a focus lens group.

The zoom optical system ZL according to the first embodiment and the second embodiment may satisfy the following conditional expression (4).

0.01<Bft2/ft2<0.30 (4)
Where Bft2: a back focus of the zoom optical system ZL in the second telephoto end state.

The conditional expression (4) defines an appropriate relationship between the back focus of the zoom optical system ZL in the second telephoto end state and the focal length of the zoom optical system ZL in the second telephoto end state. By satisfying the conditional expression (4), it is possible to obtain a zoom optical system having bright and favorable optical performance while being compact. By setting an upper limit value of the conditional expression (4) to 0.20, 0.15, 0.10, or further 0.06, it is possible to more reliably achieve the effect of each embodiment. By setting a lower limit value of the conditional expression (4) to 0.02 or further 0.04, it is possible to more reliably achieve the effect of each embodiment.

In the zoom optical system ZL according to the first embodiment and the second embodiment, the rear group GR includes a final lens group GE arranged closest to the image surface. When zooming from the wide-angle end state to the first telephoto end state, when zooming from the first telephoto end state to the second telephoto end state, and when zooming, the final lens group GE may be fixed relative to the image surface I. With this, it is possible to make the zoom optical system compact.

Also, in the zoom optical system ZL according to the first embodiment and the second embodiment, when zooming from the first telephoto end state to the second telephoto end state, the third lens group G3 may be fixed relative to the image surface I.

The zoom optical system ZL according to the first embodiment and the second embodiment may satisfy the following conditional expression (5).

0.75<D23/(−f2)<1.40 (5)
Where f2: the focal length of the second lens group G2,
D23: a change amount of a distance on the optical axis between the second lens group G2 and the third lens group G3 when zooming from the wide-angle end state to the first telephoto end state.

The conditional expression (5) defines an appropriate relationship between the change amount of the distance on the optical axis between the second lens group G2 and the third lens group G3 when zooming from the wide-angle end state to the first telephoto end state, and the focal length of the second lens group G2. In each embodiment, the change amount of the distance on the optical axis between the second lens group G2 and the third lens group G3 when zooming from the wide-angle end state to the first telephoto end state indicates a difference (absolute value) between the distance on the optical axis between the second lens group G2 and the third lens group G3 in the first telephoto end state and the distance on the optical axis between the second lens group G2 and the third lens group G3 in the wide-angle end state. By satisfying the conditional expression (5), spherical aberration and coma aberration can be favorably corrected.

When a corresponding value of the conditional expression (5) exceeds an upper limit value, the refractive power of the second lens group G2 increases, which complicates correcting spherical aberration, coma aberration, and curvature of field that occur in the second lens group G2. By setting the upper limit value of the conditional expression (5) to 1.30 or further 1.25, it is possible to more reliably achieve the effect of each embodiment.

When the corresponding value of the conditional expression (5) falls below a lower limit value, the change amount of the distance on the optical axis between the second lens group G2 and the third lens group G3 when zooming from the wide-angle end state to the first telephoto end state decreases, which complicates correcting spherical aberration and coma aberration since it is necessary to increase the refractive power of the second lens group G2. By setting the lower limit value of the conditional expression (5) to 0.80 or further 0.85, it is possible to more reliably achieve the effect of each embodiment.

The zoom optical system ZL according to the first embodiment and the second embodiment may satisfy the following conditional expression (6).

0.45<D23/f3<1.00 (6)
Where f3: a focal length of the third lens group G3, and
D23: the change amount of the distance on the optical axis between the second lens group G2 and the third lens group G3 when zooming from the wide-angle end state to the first telephoto end state.

The conditional expression (6) defines an appropriate relationship between the change amount of the distance on the optical axis between the second lens group G2 and the third lens group G3 when zooming from the wide-angle end state to the first telephoto end state, and the focal length of the third lens group G3. By satisfying the conditional expression (6), spherical aberration and coma aberration can be favorably corrected.

When a corresponding value of the conditional expression (6) exceeds an upper limit value, the refractive power of the third lens group G3 increases, which complicates correcting spherical aberration and coma aberration that occur in the third lens group G3. By setting the upper limit value of the conditional expression (6) to 0.90 or further 0.85, it is possible to more reliably achieve the effect of each embodiment.

When the corresponding value of the conditional expression (6) falls below a lower limit value, the change amount of the distance on the optical axis between the second lens group G2 and the third lens group G3 when zooming from the wide-angle end state to the first telephoto end state decreases, which complicates correcting spherical aberration and coma aberration since it is necessary to increase the refractive power of the second lens group G2. By setting the lower limit value of the conditional expression (6) to 0.50 or further 0.60, it is possible to more reliably achieve the effect of each embodiment.

In the zoom optical system ZL according to the first embodiment and the second embodiment, the rear group GR includes at least two focus lens group that move along the optical axis when focusing, and may satisfy the following conditional expression (7).

0<MF1w/MF1t<1.00 (7)
Where MF1w: a movement amount of a first focus lens group GF1 arranged closest to the object among the at least two focus lens groups, when zooming from the wide-angle end state to the first telephoto end state, and
MF1t: a movement amount of the first focus lens group GF1 when zooming from the first telephoto end state to the second telephoto end state.

The conditional expression (7) defines an appropriate relationship between the movement amount of the first focus lens group GF1 when zooming from the wide-angle end state to the first telephoto end state, and the movement amount of the first focus lens group GF1 when zooming from the first telephoto end state to the second telephoto end state. By satisfying the conditional expression (7), spherical aberration and curvature of field can be favorably corrected.

When a corresponding value of the conditional expression (7) exceeds an upper limit value, the movement amount of the first focus lens group GF1 when zooming from the first telephoto end state to the second telephoto end state decreases, which complicates correcting spherical aberration and curvature of field that occur in the first focus lens group GF1. By setting the upper limit value of the conditional expression (7) to 0.80 or further 0.60, it is possible to more reliably achieve the effect of each embodiment.

When the corresponding value of the conditional expression (7) falls below a lower limit value, the movement amount of the first focus lens group GF1 when zooming from the wide-angle end state to the first telephoto end state decreases, which complicates correcting spherical aberration and curvature of field that occur in the first focus lens group GF1. By setting the lower limit value of the conditional expression (7) to 0.002, 0.10, or further 0.20, it is possible to more reliably achieve the effect of each embodiment.

In the zoom optical system ZL according to the first embodiment and the second embodiment, the rear group GR includes at least two focus lens group that move along the optical axis when focusing, and may satisfy the following conditional expression (8).

0.05<MF2w/MF2t<10.00 (8)
Where MF2w: a movement amount of a second focus lens group GF2 arranged second closest to the object among the at least two focus lens groups, when zooming from the wide-angle end state to the first telephoto end state, and
MF2t: a movement amount of the second focus lens group GF2 when zooming from the first telephoto end state to the second telephoto end state.

The conditional expression (8) defines an appropriate relationship between the movement amount of the second focus lens group GF2 when zooming from the wide-angle end state to the first telephoto end state, and the movement amount of the second focus lens group GF2 when zooming from the first telephoto end state to the second telephoto end state. By satisfying the conditional expression (8), spherical aberration and curvature of field can be favorably corrected.

When a corresponding value of the conditional expression (8) exceeds an upper limit value, the movement amount of the second focus lens group GF2 when zooming from the first telephoto end state to the second telephoto end state decreases, which complicates correcting spherical aberration and curvature of field that occur in the second focus lens group GF2. By setting the upper limit value of the conditional expression (8) to 8.00 or further 6.00, it is possible to more reliably achieve the effect of each embodiment.

When the corresponding value of the conditional expression (8) falls below a lower limit value, the movement amount of the second focus lens group GF2 when zooming from the wide-angle end state to the first telephoto end state decreases, which complicates correcting spherical aberration and curvature of field that occur in the second focus lens group GF2. By setting the lower limit value of the conditional expression (8) to 0.10 or further 0.20, it is possible to more reliably achieve the effect of each embodiment.

The zoom optical system ZL according to the first embodiment and the second embodiment may satisfy the following conditional expression (9).

0.01<MC/MB<2.00 (9)
Where MB: the movement amount of the lens group with the largest movement amount when zooming from the first telephoto end state to the second telephoto end state, and
MC: a movement amount of a lens group with the smallest movement amount when zooming from the first telephoto end state to the second telephoto end state.

The conditional expression (9) defines an appropriate relationship between the movement amount of the lens group with the largest movement amount when zooming from the first telephoto end state to the second telephoto end state, and the movement amount of the lens group with the smallest movement amount when zooming from the first telephoto end state to the second telephoto end state. By satisfying the conditional expression (9), spherical aberration, coma aberration, and curvature of field can be favorably corrected.

When a corresponding value of the conditional expression (9) exceeds an upper limit value, the movement amount of the lens group with the largest movement amount when zooming from the first telephoto end state to the second telephoto end state decreases, which complicates correcting spherical aberration, coma aberration, and curvature of field that occur in the lens group. By setting the upper limit value of the conditional expression (9) to 1.20, 1.10, 1.00, 0.85, or further 0.75, it is possible to more reliably achieve the effect of each embodiment.

When the corresponding value of the conditional expression (9) falls below a lower limit value, the movement amount of the lens group with the smallest movement amount when zooming from the first telephoto end state to the second telephoto end state decreases, which complicates correcting spherical aberration, coma aberration, and curvature of field that occur in the lens group. By setting the lower limit value of the conditional expression (9) to 0.03 or further 0.05, it is possible to more reliably achieve the effect of each embodiment.

The zoom optical system ZL according to the first embodiment and the second embodiment may satisfy the following conditional expression (10).

0.10<Bft2/MB<5.00 (10)
Where MB: the movement amount of the lens group with the largest movement amount when zooming from the first telephoto end state to the second telephoto end state, and
Bft2: the back focus of the zoom optical system ZL in the second telephoto end state.

The conditional expression (10) defines an appropriate relationship between the back focus of the zoom optical system ZL in the second telephoto end state, and the movement amount of the lens group with the largest movement amount when zooming from the first telephoto end state to the second telephoto end state. By satisfying the conditional expression (10), it is possible to obtain a zoom optical system having bright and favorable optical performance while being compact. By setting an upper limit value of the conditional expression (10) to 3.00 or further 1.20, it is possible to more reliably achieve the effect of each embodiment. By setting a lower limit value of the conditional expression (10) to 0.30 or further 0.60, it is possible to more reliably achieve the effect of each embodiment.

The zoom optical system ZL according to the first embodiment and the second embodiment may satisfy the following conditional expression (11).

0.05<(−f2)/f1<1.00 (11)
Where f1: a focal length of the first lens group G1, and
f2: the focal length of the second lens group G2.

The conditional expression (11) defines an appropriate relationship between the focal length of the second lens group G2, and the focal length of the first lens group G1. By satisfying the conditional expression (11), spherical aberration, coma aberration, and curvature of field can be favorably corrected.

When a corresponding value of the conditional expression (11) exceeds an upper limit value, the refractive power of the first lens group G1 increases, which complicates correcting spherical aberration, coma aberration, and curvature of field that occur in the first lens group G1. By setting the upper limit value of the conditional expression (11) to 0.80, 0.70, 0.50, 0.40, or further 0.37, it is possible to more reliably achieve the effect of each embodiment.

When the corresponding value of the conditional expression (11) falls below a lower limit value, the refractive power of the second lens group G2 increases, which complicates correcting spherical aberration, coma aberration, and curvature of field that occur in the second lens group G2. By setting the lower limit value of the conditional expression (11) to 0.10, 0.15, 0.20, 0.25, or further 0.30, it is possible to more reliably achieve the effect of each embodiment.

The zoom optical system ZL according to the first embodiment and the second embodiment may satisfy the following conditional expression (12).

0.01<Bfw/fw<0.50 (12)
Where fw: a focal length of the zoom optical system ZL in the wide-angle end state, and
Bfw: a back focus of the zoom optical system ZL in the wide-angle end state.

The conditional expression (12) defines an appropriate relationship between the back focus of the zoom optical system ZL in the wide-angle end state and the focal length of the zoom optical system ZL in the wide-angle end state. By satisfying the conditional expression (12), it is possible to obtain a zoom optical system having bright and favorable optical performance while being compact. By setting an upper limit value of the conditional expression (12) to 0.45, 0.40, 0.35, 0.33, 0.30, or further 0.28, it is possible to more reliably achieve the effect of each embodiment. By setting a lower limit value of the conditional expression (12) to 0.05, 0.10, or further 0.13, it is possible to more reliably achieve the effect of each embodiment.

The zoom optical system ZL according to the first embodiment and the second embodiment may satisfy the following conditional expression (13).

2.00<TLw/fw<6.00 (13)
Where fw: the focal length of the zoom optical system ZL in the wide-angle end state, and
TLw: an entire length of the zoom optical system ZL in the wide-angle end state.

The conditional expression (13) defines an appropriate relationship between the entire length of the zoom optical system ZL in the wide-angle end state and the focal length of the zoom optical system ZL in the wide-angle end state. By satisfying the conditional expression (13), it is possible to obtain a zoom optical system having bright and favorable optical performance while being compact. By setting an upper limit value of the conditional expression (13) to 5.50, 5.00, 4.50, or further 4.00, it is possible to more reliably achieve the effect of each embodiment. By setting a lower limit value of the conditional expression (13) to 2.50, 2.80, 3.00, or further 3.10, it is possible to more reliably achieve the effect of each embodiment.

The zoom optical system ZL according to the first embodiment and the second embodiment may satisfy the following conditional expression (14).

0.01<(−f2)/f3<2.00 (14)
Where f2: the focal length of the second lens group G2, and
f3: the focal length of the third lens group G3.

The conditional expression (14) defines an appropriate relationship between the focal length of the second lens group G2 and the focal length of the third lens group G3. By satisfying the conditional expression (14), spherical aberration, coma aberration, and curvature of field can be favorably corrected.

When a corresponding value of the conditional expression (14) exceeds an upper limit value, the refractive power of the third lens group G3 increases, which complicates correcting spherical aberration, coma aberration, and curvature of field that occur in the third lens group G3. By setting the upper limit value of the conditional expression (14) to 1.80, 1.60, 1.50, 1.35, 1.10, or further 1.00, it is possible to more reliably achieve the effect of the present embodiment.

When the corresponding value of the conditional expression (14) falls below a lower limit value, the refractive power of the second lens group G2 increases, which complicates correcting spherical aberration, coma aberration, and curvature of field that occur in the second lens group G2. By setting the lower limit value of the conditional expression (14) to 0.10, 0.20, 0.30, 0.35, 0.45, 0.50, or further 0.55, it is possible to more reliably achieve the effect of the present embodiment.

The zoom optical system ZL according to the first embodiment and the second embodiment may satisfy the following conditional expression (15).

1.80<f1/f3<2.50 (15)
Where f1: the focal length of the first lens group G1, and
f3: the focal length of the third lens group G3.

The conditional expression (15) defines an appropriate relationship between the focal length of the first lens group G1 and the focal length of the third lens group G3. By satisfying the conditional expression (15), spherical aberration, coma aberration, and curvature of field can be favorably corrected.

When a corresponding value of the conditional expression (15) exceeds an upper limit value, the refractive power of the third lens group G3 increases, which complicates correcting spherical aberration, coma aberration, and curvature of field that occur in the third lens group G3. By setting the upper limit value of the conditional expression (15) to 2.45, 2.40, or further 2.35, it is possible to more reliably achieve the effect of the present embodiment.

When the corresponding value of the conditional expression (15) falls below a lower limit value, the refractive power of the first lens group G1 increases, which complicates correcting spherical aberration, coma aberration, and curvature of field that occur in the first lens group G1. By setting the lower limit value of the conditional expression (15) to 1.85 or further 1.90, it is possible to more reliably achieve the effect of the present embodiment.

In the zoom optical system ZL according to the first embodiment and the second embodiment, the rear group GR includes the final lens group GE arranged closest to the image surface, and may satisfy the following conditional expression (16).

0.01<|fr1/fr|<5.00 (16)
Where fr: a focal length of the final lens group GE, and
fr1: a focal length of a lens group arranged in order from the object of the final lens group GE in the rear group GR.

The conditional expression (16) defines an appropriate relationship between the focal length of the lens group arranged in order from the object of the final lens group GE in the rear group GR, and the focal length of the final lens group GE. By satisfying the conditional expression (16), curvature of field can be favorably corrected.

When a corresponding value of the conditional expression (16) exceeds an upper limit value, a refractive power of the final lens group GE increases, which complicates correcting curvature of field that occurs in the final lens group GE. By setting the upper limit value of the conditional expression (16) to 4.80, 4.50, 4.30, 3.50, 3.30, 3.00, 2.80, or further 2.50, it is possible to more reliably achieve the effect of the present embodiment.

When the corresponding value of the conditional expression (16) falls below a lower limit value, a refractive power of the lens group arranged in order from the object of the final lens group GE in the rear group GR increases, which complicates correcting coma aberration and curvature of field that occur in the lens group arranged in order from the object of the final lens group GE. By setting the lower limit value of the conditional expression (16) to 0.10, 0.20, 0.25, 0.35, 0.45, or further 0.50, it is possible to more reliably achieve the effect of the present embodiment.

In the zoom optical system ZL according to the first embodiment and the second embodiment, the rear group GR includes the final lens group GE arranged closest to the image surface, and may satisfy the following conditional expression (17).

0.10<f2/fr1<0.75 (17)
Where f2: the focal length of the second lens group G2, and
fr1: the focal length of the lens group arranged in order from the object of the final lens group GE in the rear group GR.

The conditional expression (17) defines an appropriate relationship between the focal length of the second lens group G2, and the focal length of the lens group arranged in order from the object of the final lens group GE in the rear group GR. By satisfying the conditional expression (17), coma aberration and curvature of field can be favorably corrected.

When a corresponding value of the conditional expression (17) exceeds an upper limit value, the refractive power of the lens group arranged in order from the object of the final lens group GE in the rear group GR increases, which complicates correcting coma aberration and curvature of field that occur in the lens group arranged in order from the object of the final lens group GE. By setting the upper limit value of the conditional expression (17) to 0.70 or further 0.68, it is possible to more reliably achieve the effect of the present embodiment.

When the corresponding value of the conditional expression (17) falls below a lower limit value, the refractive power of the second lens group G2 increases, which complicates correcting spherical aberration, coma aberration, and curvature of field that occur in the second lens group G2. By setting the lower limit value of the conditional expression (17) to 0.15 or further 0.20, it is possible to more reliably achieve the effect of the present embodiment.

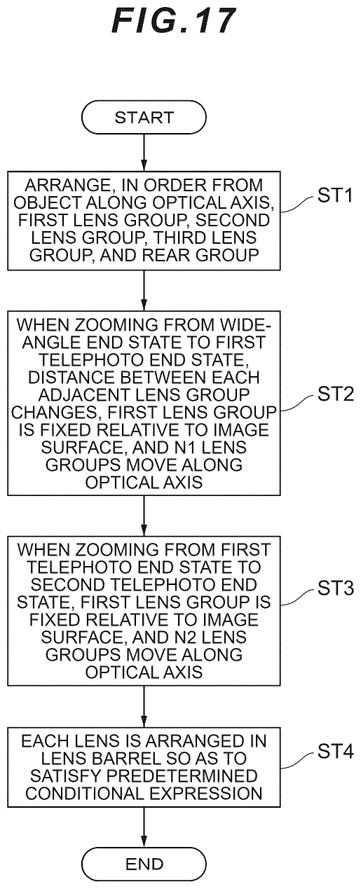

Next, a method of manufacturing the zoom optical system ZL according to the first embodiment will be described with reference to FIG. 17. First, the first lens group G1 having positive refractive power, the second lens group G2 having negative refractive power, the third lens group G3 having positive refractive power, and the rear group GR are arranged in order from the object along the optical axis (step ST1). Next, when zooming from the wide-angle end state to the first telephoto end state, the distance between each adjacent lens group changes, the first lens group G1 is fixed relative to the image surface I, and N1 lens groups move along the optical axis (step ST2). When zooming from the first telephoto end state to the second telephoto end state, the first lens group G1 is fixed relative to the image surface I, and N2 lens groups move along the optical axis (step ST3). As described above, N1 is an integer of 3 or higher and N2 is a positive integer lower than N1. Each lens is arranged in a lens barrel so as to satisfy at least the above conditional expression (1) and conditional expression (2) (step ST4). According to such a manufacturing method, it is possible to manufacture a zoom optical system having bright and favorable optical performance while being compact.

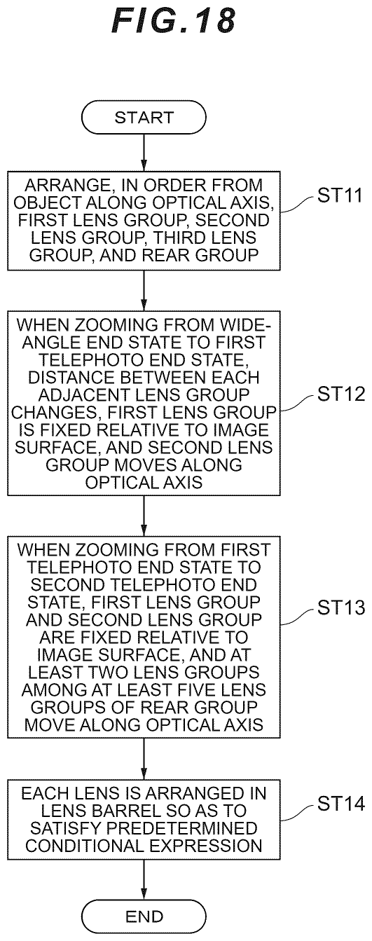

Next, a method of manufacturing the zoom optical system ZL according to the second embodiment will be described with reference to FIG. 18. First, the first lens group G1 having positive refractive power, the second lens group G2 having negative refractive power, the third lens group G3 having positive refractive power, and the rear group GR are arranged in order from the object along the optical axis (step ST11). Next, when zooming from the wide-angle end state to the first telephoto end state, the distance between each adjacent lens group changes, the first lens group G1 is fixed relative to the image surface I, and the second lens group G2 moves along the optical axis (step ST12). When zooming from the first telephoto end state to the second telephoto end state, the first lens group G1 and the second lens group G2 are fixed relative to the image surface I, and at least part of the rear group GR moves along the optical axis (step ST13). Each lens is arranged in a lens barrel so as to satisfy at least the above conditional expression (3) and conditional expression (2) (step ST14). According to such a manufacturing method, it is possible to manufacture a zoom optical system having bright and favorable optical performance while being compact.

### EXAMPLES

Hereinafter, the zoom optical system ZL according to examples of each embodiment will be described. FIGS. 1, 6, and 11 are cross-sectional diagrams showing configurations and refractive power distributions of the zoom optical system ZL {ZL(1) to ZL(3)} according to first to third examples. The cross-sectional diagrams of the zoom optical systems ZL(1) to ZL(3) according to the first to third examples show, using arrows, a movement direction of each lens group when zooming from the wide-angle end state (W) to the first telephoto end state (T1) via the medium focus state (M) and zooming from the first telephoto end state (T1) to the second telephoto end state (T2). A movement direction of the focus lens group when focusing from infinity to a short-distance object is indicated with an arrow along with the word “focusing”.

In FIGS. 1, 6, and 11, each lens group is represented by a combination of a reference sign G and a numeral, and each lens is represented by a combination of a reference sign L and a numeral. In this case, in order to prevent complication due to an increase in the types and number of reference signs and numerals, the lens groups and the like are represented using a combination of a reference sign and a numeral independently for each example. Accordingly, even if the same combination of a reference sign and a numeral is used among the examples, such use does not intend to mean the same configuration.

Hereinafter, Tables 1 to 3 are shown. Table 1 shows each piece of data for the first example, Table 2 for the second example, and Table 3 for the third example. In each example, a d-line (wavelength %=587.6 nm) and a g-line (wavelength)=435.8 nm) are selected as calculation targets of aberration characteristics.

In the [General Data] table, f indicates a focal length of an entire lens system, FNO indicates an F-number, @ indicates a half angle of view (unit thereof is ° (degrees), and Y indicates an image height. TL indicates a distance obtained by adding Bf (back focus) to a distance on the optical axis from a lens surface closest to the object to a lens surface closest to the image surface of the zoom optical system upon focusing on infinity. Bf indicates a distance on the optical axis from a lens surface closest to the image surface to the image surface of the zoom optical system upon focusing on infinity. Note that these values are indicated for each zoom state, namely the wide-angle end state (W), the medium focal length state (M), the first telephoto end state (T1), and the second telephoto end state (T2).

Also, in the [General Data] table, MA indicates the movement amount of the lens group with the largest movement amount when zooming from the wide-angle end state to the first telephoto end state. MB indicates the movement amount of the lens group with the largest movement amount when zooming from the first telephoto end state to the second telephoto end state. MC indicates the movement amount of the lens group with the smallest movement amount when zooming from the first telephoto end state to the second telephoto end state. MG2 indicates the movement amount of the second lens group when zooming from the wide-angle end state to the first telephoto end state. D23 indicates the change amount of the distance on the optical axis between the second lens group and the third lens group when zooming from the wide-angle end state to the first telephoto end state. MF1w indicates the movement amount of the first focus lens group when zooming from the wide-angle end state to the first telephoto end state. MF1t indicates the movement amount of the first focus lens group when zooming from the first telephoto end state to the second telephoto end state. MF2w indicates the movement amount of the second focus lens group when zooming from the wide-angle end state to the first telephoto end state. MF2t indicates the movement amount of the second focus lens group when zooming from the first telephoto end state to the second telephoto end state. Note that the zooming ratio (telephoto magnification) in the second telephoto state is greater than the zooming ratio (telephoto magnification) in the first telephoto state. That is, it is possible to increase the telephoto magnification by switching from the first telephoto state to the second telephoto state.

In the [Lens Data] table, a surface number indicates an order of optical surfaces from the object along a direction in which a light beam travels, R indicates a radius of curvature of each optical surface (a surface whose center of curvature is located at an image side is defined as a positive value), D indicates a surface distance being a distance on the optical axis from each optical surface to the next optical surface (or image surface), nd indicates a refractive index of a material of an optical member for the d-line, and νd indicates an Abbe number of the material of the optical member with respect to the d-line, respectively. A radius of curvature of “∞” indicates a plane or an opening, and (aperture stop S) indicates an aperture stop S, respectively. Description of the refractive index nd of air=1.00000 is omitted. When the optical surface is an aspherical surface, a * symbol is assigned to the surface number, and a paraxial radius of curvature is shown in a radius of curvature R column.

In the [Aspherical surface data] table, a shape of an aspherical surface shown in [Lens Data] is indicated by the following expression (A). X(y) indicates a distance (sag amount) from a tangent plane at a vertex of the aspherical surface to a position on the aspherical surface at a height y along an optical axis direction. R indicates the radius of curvature (paraxial radius of curvature) of a reference spherical surface. K indicates a conic constant. Ai indicates an i-th aspherical coefficient. “E-n” indicates “×10⁻ⁿ”. For example, 1.234E-05=1.234×10⁻⁵. Note that a secondary aspherical coefficient A2 is 0, and description thereof is omitted.

X(y)=(y²/R)/{1+(1−κ×y²/R²)^{1/2}}+A4×y⁴+A6×y⁶+A8×y⁸+A10×y¹⁰ (A)

The [Variable distance data] table shows surface distances at a surface number i where a surface distance is (Di) in the [Lens Data] table. The [Variable distance data] table shows surface distances upon focusing on infinity and surface distances upon focusing on a short-distance object. DO indicates a distance from the object to a lens surface closest to the object in the zoom optical system.

The [Lens group data] table shows a first surface (surface closest to the object) of each lens group and the focal length.

Hereinafter, among all data values, “mm” is generally used for the focal length f, radius of curvature R, surface distance D, other lengths, and the like listed when not otherwise specified. However, since the optical system can achieve equivalent optical performance even when being proportionally enlarged or reduced, the optical system is not limited thereto.

The description of the tables up to this point is shared between all of the examples, and hereinafter, overlapping description is omitted.

### First Example

The first example will be described with reference to FIGS. 1 to 5 and Table 1. FIG. 1 is a diagram showing a lens configuration of the zoom optical system according to the first example. The zoom optical system ZL(1) according to the first example comprises, in order from the object along the optical axis, the first lens group G1 having positive refractive power, the second lens group G2 having negative refractive power, the third lens group G3 having positive refractive power, a fourth lens group G4 having negative refractive power, a fifth lens group G5 having positive refractive power, a sixth lens group G6 having positive refractive power, a seventh lens group G7 having positive refractive power, an eighth lens group G8 having negative refractive power, and a ninth lens group G9 having positive refractive power.

When zooming from the wide-angle end state (W) to the first telephoto end state (T1) via the medium focus state (M), the second lens group G2, the fourth lens group G4, the fifth lens group G5, the sixth lens group G6, the seventh lens group G7, and the eighth lens group G8 move along the optical axis as indicated by the arrows in FIG. 1, and the distance between each adjacent lens group changes. That is, when zooming from the wide-angle end state to the first telephoto end state, N1=6 lens groups move along the optical axis. Note that when zooming from the wide-angle end state to the first telephoto end state, the first lens group G1, the third lens group G3, and the ninth lens group G9 are fixed relative to the image surface I.

When zooming from the first telephoto end state (T1) to the second telephoto end state (T2), the fourth lens group G4 and the sixth lens group G6 move toward the image surface along the optical axis at different trajectories (movement amounts), and the eighth lens group G8 moves toward the object along the optical axis. That is, when zooming from the first telephoto end state to the second telephoto end state, N2=3 lens groups move along the optical axis. Note that when zooming from the first telephoto end state to the second telephoto end state, the first lens group G1, the second lens group G2, the third lens group G3, the fifth lens group G5, the seventh lens group G7, and the ninth lens group G9 are fixed relative to the image surface I. Also, the aperture stop S is arranged between the third lens group G3 and the fourth lens group G4, and the aperture stop S is fixed relative to the image surface I along with the third lens group G3 when zooming. The reference signs (+) or (−) assigned to each lens group symbol indicate the refractive power of each lens group, and this applies to all of the following examples.

The first lens group G1 comprises, in order from the object along the optical axis, a cemented positive lens obtained by cementing together a meniscus-shaped negative lens L11 having a convex surface facing the object and a biconvex positive lens L12, and a meniscus-shaped positive lens L13 having a convex surface facing the object.

The second lens group G2 comprises, in order from the object along the optical axis, a meniscus-shaped negative lens L21 having a convex surface facing the object, a biconcave negative lens L22, a meniscus-shaped positive lens L23 having a convex surface facing the object, and a biconcave negative lens L24. The second lens group G2 is the lens group with the largest movement amount when zooming from the wide-angle end state to the first telephoto end state.

The third lens group G3 comprises, in order from the object along the optical axis, a meniscus-shaped positive lens L31 having a convex surface facing the object, a meniscus-shaped positive lens L32 having a convex surface facing the object, and a cemented positive lens obtained by cementing together a meniscus-shaped negative lens L33 having a convex surface facing the object and a meniscus-shaped positive lens L34 having a convex surface facing the object.

The fourth lens group G4 comprises, in order from the object along the optical axis, a biconcave negative lens L41, and a cemented negative lens obtained by cementing together a biconcave negative lens L42 and a meniscus-shaped positive lens L43 having a convex surface facing the object. The fourth lens group G4 is the lens group with the largest movement amount when zooming from the first telephoto end state to the second telephoto end state.

The fifth lens group G5 comprises, in order from the object along the optical axis, a biconvex positive lens L51, and a cemented positive lens obtained by cementing together a biconvex positive lens L52 and a biconcave negative lens L53. An object-side lens surface of the positive lens L51 is an aspherical surface.

The sixth lens group G6 comprises a biconvex positive lens L61. The sixth lens group G6 is the lens group with the smallest movement amount when zooming from the first telephoto end state to the second telephoto end state.

The seventh lens group G7 comprises, in order from the object along the optical axis, a meniscus-shaped positive lens L71 having a concave surface facing the object, a meniscus-shaped negative lens L72 having a convex surface facing the object, a cemented negative lens obtained by cementing together a biconvex positive lens L73 and a biconcave negative lens L74, and a biconvex positive lens L75. An image surface-side lens surface of the meniscus-shaped negative lens L72 is an aspherical surface.

The eighth lens group G8 comprises a meniscus-shaped negative lens L81 having a concave surface facing the object.

The ninth lens group G9 comprises, in order from the object along the optical axis, a meniscus-shaped negative lens L91 having a concave surface facing the object and a biconvex positive lens L92. The image surface I is arranged on the image side from the ninth lens group G9.

In the present example, the fourth lens group G4, the fifth lens group G5, the sixth lens group G6, the seventh lens group G7, the eighth lens group G8, and the ninth lens group G9 constitute the rear group GR. In the rear group GR, the fourth lens group G4 corresponds to the first focus lens group GF1, and the sixth lens group G6 corresponds to the second focus lens group GF2. The eighth lens group G8 corresponds to the third focus lens group GF3, and the ninth lens group G9 corresponds to the final lens group GE.

When focusing from an infinity object to the short-distance object in the wide-angle end state, the first focus lens group GF1 (fourth lens group G4) and the third focus lens group GF3 (eighth lens group G8) move toward the image surface along the optical axis at different trajectories (movement amounts), and the second focus lens group GF2 (sixth lens group G6) moves toward the object along the optical axis. When focusing from the infinity object to the short-distance object in a medium focal length state and the first telephoto end state, the first focus lens group GF1 (fourth lens group G4) and the second focus lens group GF2 (sixth lens group G6) move toward the object along the optical axis at different trajectories (movement amounts), and the third focus lens group GF3 (eighth lens group G8) moves toward the image surface along the optical axis. When focusing from the infinity object to the short-distance object in the second telephoto end state, the second focus lens group GF2 (sixth lens group G6) moves toward the object along the optical axis, and the third focus lens group GF3 (eighth lens group G8) moves toward the image surface along the optical axis. Also, when zooming from the first telephoto end state to the second telephoto end state, the first focus lens group GF1 (fourth lens group G4) and the second focus lens group GF2 (sixth lens group G6) move toward the image surface along the optical axis at different trajectories (movement amounts), and the third focus lens group GF3 (eighth lens group G8) moves toward the object along the optical axis.

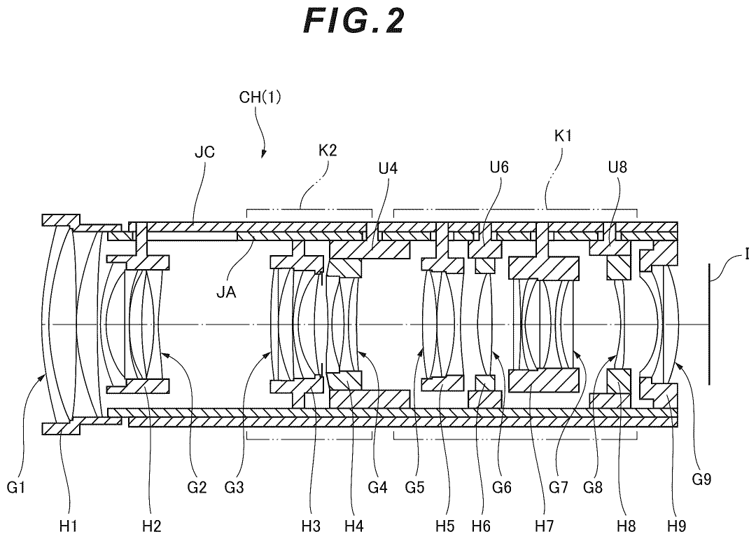

As described above, the zoom optical system ZL(1) according to the first example is provided in the photographic lens 3 (see FIG. 16) attached to the main body 2 of the camera 1. Note that the photographic lens 3 is also referred to as a lens barrel. As schematically shown in FIG. 2, first to ninth group frames H1 to H9, a fixed barrel JA, and a cam barrel JC are built into the photographic lens 3 (lens barrel) as a lens position control mechanism CH(1) according to the first example. The first lens group G1 is held by the first group frame H1. The second lens group G2 is held by the second group frame H2. The third lens group G3 is held by the third group frame H3. The fourth lens group G4 is held by the fourth group frame H4. The fifth lens group G5 is held by the fifth group frame H5. The sixth lens group G6 is held by the sixth group frame H6. The seventh lens group G7 is held by the seventh group frame H7. The eighth lens group G8 is held by the eighth group frame H8. The ninth lens group G9 is held by the ninth group frame H9.

The cam barrel JC is arranged at an outer circumference side of the fixed barrel JA to be rotatable relative to the fixed barrel JA. The first group frame H1 is fixed to the fixed barrel JA closest to the object. The ninth group frame H9 is fixed to the fixed barrel JA closest to the image surface. The second group frame H2, the third group frame H3, a fourth group barrel member U4, the fifth group frame H5, a sixth group barrel member U6, the seventh group frame H7, and an eighth group barrel member U8 are arranged at an inner side of the fixed barrel JA in order from the object. Note that the third group frame H3 is fixed at the inner side of the fixed barrel JA. The fourth group frame H4 is arranged at an inner side of the fourth group barrel member U4. The sixth group frame H6 is arranged at an inner side of the sixth group barrel member U6. The eighth group frame H8 is arranged at an inner side of the eighth group barrel member U8. Also, a plurality of guide bars extending along the optical axis direction are provided at an inner circumferential portion of the fixed barrel JA, and engage with guide grooves of corresponding lens group frames and barrel members.

A plurality of cam grooves are formed in the cam barrel JC, and cam followers of corresponding lens group frames and barrel members engage therewith. As indicated by dash-double-dot lines in FIG. 2, a first operation ring K1 and a second operation ring K2 are provided at the outer circumference side of the cam barrel JC so as to be rotatable relative to the fixed barrel JA.

The first operation ring K1 is a so-called zoom ring and a user can perform a rotation operation thereon. A first detection part (not shown) that detects a rotation amount of the first operation ring K1 is provided at an inner side of the first operation ring K1. The first detection part outputs the rotation amount, a rotation speed to a control part (not shown) in the photographic lens 3 (lens barrel) upon detecting rotation of the first operation ring K1. An operation switch (not shown) on which an operation (for example, a push operation) is performed for increasing a rotational range of the first operation ring K1 is provided at an outer circumference side of the first operation ring K1. The user can perform a zoom operation between the wide-angle end state and the first telephoto end state by rotating the first operation ring K1 without pressing or operating the operation switch. The user can perform a zoom operation between the wide-angle end state and the second telephoto end state by rotating the first operation ring K1 in a state in which the operation switch has been pressed and operated.

The user can perform a rotation operation on the second operation ring K2, and a function of operating through the rotation operation can be set in the main body 2 of the camera 1 or the photographic lens 3. The user can change optical properties such as focus position, focal length, or aperture stop value by, for example, performing the rotation operation on the second operation ring K2. A second detection part (not shown) that detects a rotation amount of the second operation ring K2 is provided at an inner diameter side of the second operation ring K2. When the user performs the rotation operation on the second operation ring K2, the second detection part detects rotation amount, a rotation speed of the second operation ring K2, and outputs the rotation amount, the rotation speed to the control part (not shown) in the photographic lens 3 (lens barrel). The control part drives and controls a motor (a fourth group drive motor, sixth group drive motor, eighth group drive motor, and the like to be described below) for changing the optical properties in accordance with the rotation amount of the second operation ring K2.

A fourth group drive unit (not shown) is provided at the fourth group barrel member U4. The fourth group drive unit drives the fourth group frame H4 in the optical axis direction. The fourth group drive unit can drive the fourth lens group G4 (first focus lens group GF1) held by the fourth group frame H4 in the optical axis direction not only when focusing but also when zooming from the first telephoto end state to the second telephoto end state. For example, the fourth group drive unit includes the fourth group drive motor (not shown), a fourth group lead screw (not shown), and a fourth group rack (not shown). The fourth group drive motor is, for example, a stepping motor and is fixed to the fourth group barrel member U4. The fourth group lead screw includes a threaded portion, is formed in a shaft shape extending in the optical axis direction, and is connected to an output shaft of the fourth group drive motor to rotate. The fourth group rack engages with the threaded portion of the fourth group lead screw and is connected to the fourth group frame H4. Note that a drive mechanism for driving the fourth group frame H4 in the optical axis direction can be modified as necessary.

A sixth group drive unit (not shown) is provided at the sixth group barrel member U6. The sixth group drive unit drives the sixth group frame H6 in the optical axis direction. The sixth group drive unit can drive the sixth lens group G6 (second focus lens group GF2) held by the sixth group frame H6 in the optical axis direction not only when focusing but also when zooming from the first telephoto end state to the second telephoto end state. For example, the sixth group drive unit includes the sixth group drive motor (not shown), a sixth group lead screw (not shown), and a sixth group rack (not shown). The sixth group drive motor is, for example, a stepping motor and is fixed to the sixth group barrel member U6. The sixth group lead screw includes a threaded portion, is formed in a shaft shape extending in the optical axis direction, and is connected to an output shaft of the sixth group drive motor to rotate. The sixth group rack engages with the threaded portion of the sixth group lead screw and is connected to the sixth group frame H6. Note that a drive mechanism for driving the sixth group frame H6 in the optical axis direction can be modified as necessary.

An eighth group drive unit (not shown) is provided at the eighth group barrel member U8. The eighth group drive unit drives the eighth group frame H8 in the optical axis direction. The eighth group drive unit can drive the eighth lens group G8 (third focus lens group GF3) held by the eighth group frame H8 in the optical axis direction not only when focusing but also when zooming from the first telephoto end state to the second telephoto end state. For example, the eighth group drive unit includes the eighth group drive motor (not shown), an eighth group lead screw (not shown), and an eighth group rack (not shown). The eighth group drive motor is, for example, a stepping motor and is fixed to the eighth group barrel member U8. The eighth group lead screw includes a threaded portion, is formed in a shaft shape extending in the optical axis direction, and is connected to an output shaft of the eighth group drive motor to rotate. The eighth group rack engages with the threaded portion of the eighth group lead screw and is connected to the eighth group frame H8. Note that a drive mechanism for driving the eighth group frame H8 in the optical axis direction can be modified as necessary.

When zooming from the wide-angle end state to the first telephoto end state, the second group frame H2, the fourth group barrel member U4, the fifth group frame H5, the sixth group barrel member U6, the seventh group frame H7, and the eighth group barrel member U8 are driven in the optical axis direction through the rotation of the cam barrel JC that rotates via the rotation of the first operation ring K1. When zooming from the first telephoto end state to the second telephoto end state or when focusing, the fourth group frame H4 is driven in the optical axis direction relative to the fourth group barrel member U4 by the fourth group drive unit (not shown) provided at the fourth group barrel member U4 in accordance with the rotation of the first operation ring K1 or the second operation ring K2. The sixth group frame H6 is also driven in the optical axis direction relative to the sixth group barrel member U6 by the sixth group drive unit (not shown) provided at the sixth group barrel member U6 in accordance with the rotation of the first operation ring K1 or the second operation ring K2. The eighth group frame H8 is also driven in the optical axis direction relative to the eighth group barrel member U8 by the eighth group drive unit (not shown) provided at the eighth group barrel member U8 in accordance with the rotation of the first operation ring K1 or the second operation ring K2.

That is, the second lens group G2, the fifth lens group G5, and the seventh lens group G7 are mechanically driven in the optical axis direction when the first operation ring K1 is rotated. The fourth lens group G4, the sixth lens group G6, and the eighth lens group G8 are driven mechanically and electrically (motor drive control) in the optical axis direction when the first operation ring K1 is rotated, and driven electrically in the optical axis direction when the second operation ring K2 is rotated and a focus operation is instructed.

In this way, the second lens group G2, the fourth lens group G4, the fifth lens group G5, the sixth lens group G6, the seventh lens group G7, and the eighth lens group G8 are driven in the optical axis direction when zooming from the wide-angle end state to the first telephoto end state. As described above, in zooming from the wide-angle end state (W) to the first telephoto end state (T1) via the medium focus state (M), the focal length of the entire optical system is continuously changed while forming an image on the same plane and control is performed for zooming so that an appropriate focal length is achieved for any state from the wide-angle end state (W) to the first telephoto end state (T1). Note that this also applies to the second and third examples described below.

Furthermore, the fourth lens group G4, the sixth lens group G6, and the eighth lens group G8 are driven in the optical axis direction when zooming from the first telephoto end state to the second telephoto end state. As described above, zooming (switching) from the first telephoto end state (T1) to the second telephoto end state (T2) does not require continuously changing the focal length, and as long as it is possible to form an image in focus at least in the first telephoto end state (T1) and the second telephoto end state (T2), image formation performance therebetween is not required. Therefore, zooming from the first telephoto end state (T1) to the second telephoto end state (T2) does not require continuous control like when zooming from the wide-angle end state (W) to the first telephoto end state (T1), and may be intermittent (discontinuous, discrete). Note that this also applies to the second and third examples described below.

The fourth lens group G4, the sixth lens group G6, and the eighth lens group G8 are driven in the optical axis direction when focusing. In the present example, the fourth lens group G4, the sixth lens group G6, and the eighth lens group G8 are not limited to being driven mechanically and electrically (motor drive control), and may be driven electrically in the optical axis direction. The second lens group G2, the fifth lens group G5, and the seventh lens group G7 are not limited to being driven mechanically, and may be driven electrically in the optical axis direction.

Data values of the zoom optical system according to the first example are listed in the following Table 1.

TABLE 1
[General Data]

| Zooming ratio | Zooming ratio |
|---|---|
| (W→T1) = 2.796 | (W→T2) = 4.066 |
| MA = 40.034 | MB = 16.294 |
| MC = 0.838 | MG2 = 40.034 |
| D23 = 40.034 | |
| MF1w = 0.070 | MF1t = 16.294 |
| MF2w = 1.984 | MF2t = 0.838 |

| | W | M | T1 | T2 |
|---|---|---|---|---|
| f | 71.548 | 135.050 | 200.028 | 290.942 |
| FNO | 2.880 | 2.880 | 2.880 | 4.190 |
| ω | 16.511 | 8.764 | 5.920 | 4.036 |
| Y | 21.700 | 21.700 | 21.700 | 21.700 |
| TL | 250.032 | 250.032 | 250.032 | 250.032 |
| Bf | 11.741 | 11.741 | 11.741 | 11.741 |

[Lens Data]

| Surface | | | | |
|---|---|---|---|---|
| number | R | D | nd | νd |
| 1 | 122.864 | 2.800 | 2.00100 | 29.12 |
| 2 | 90.022 | 10.167 | 1.43700 | 95.10 |
| 3 | −414.107 | 0.234 | | |
| 4 | 77.712 | 7.561 | 1.49782 | 82.57 |
| 5 | 295.979 | (D5) | | |
| 6 | 56.998 | 1.900 | 1.80400 | 46.60 |
| 7 | 31.804 | 7.084 | | |
| 8 | −4966.831 | 1.700 | 1.59319 | 67.90 |
| 9 | 67.160 | 0.100 | | |
| 10 | 44.520 | 4.643 | 1.78880 | 28.43 |
| 11 | 110.699 | 4.209 | | |
| 12 | −79.535 | 1.938 | 1.59319 | 67.90 |
| 13 | 145.761 | (D13) | | |
| 14 | 158.706 | 2.960 | 1.85000 | 27.03 |
| 15 | 1838.648 | 0.100 | | |
| 16 | 51.122 | 5.386 | 1.59319 | 67.90 |
| 17 | 376.813 | 0.248 | | |
| 18 | 53.979 | 1.988 | 1.95000 | 29.37 |
| 19 | 31.619 | 6.264 | 1.59319 | 67.90 |
| 20 | 125.967 | 2.816 | | |
| 21 | ∞ | (D21) | | (Aperture |
| | | | | Stop) |
| 22 | −323.008 | 1.690 | 1.48749 | 70.32 |
| 23 | 48.793 | 4.205 | | |
| 24 | −102.551 | 1.630 | 1.72916 | 54.61 |
| 25 | 66.748 | 3.370 | 1.94595 | 17.98 |
| 26 | 261.516 | (D26) | | |
| 27* | 109.977 | 5.481 | 1.72916 | 54.61 |
| 28 | −79.623 | 0.100 | | |
| 29 | 111.650 | 6.633 | 1.55032 | 75.50 |
| 30 | −51.225 | 1.922 | 1.84666 | 23.80 |
| 31 | 147.362 | (D31) | | |
| 32 | 56.533 | 5.446 | 1.59319 | 67.90 |
| 33 | −217.682 | (D33) | | |
| 34 | −2926.248 | 2.671 | 1.72916 | 54.61 |
| 35 | −141.449 | 0.104 | | |
| 36 | 60.090 | 1.504 | 1.90265 | 35.77 |
| 37* | 34.056 | 5.025 | | |
| 38 | 489.405 | 4.385 | 1.95000 | 29.37 |
| 39 | −55.620 | 1.609 | 1.81600 | 46.59 |
| 40 | 49.501 | 2.112 | | |
| 41 | 43.776 | 5.208 | 1.69895 | 30.13 |
| 42 | −284.027 | (D42) | | |
| 43 | −59.154 | 1.545 | 1.95375 | 32.33 |
| 44 | −465.956 | (D44) | | |
| 45 | −28.519 | 1.736 | 1.88300 | 40.69 |
| 46 | −49.853 | 0.105 | | |
| 47 | 531.811 | 5.623 | 1.75211 | 25.05 |
| 48 | −64.326 | Bf | | |

[Aspherical surface data]
27th surface
κ = 1.000, A4 = −1.64920E−06, A6 = 3.15497E−10, A8 = −5.63176E−13,
A10 = 5.03223E−16
37th surface
κ = 1.000, A4 = −5.24407E−07, A6 = 1.13434E−10, A8 = −1.32855E−12,
A10 = 4.32537E−15

[Variable distance data]

| | | | |
|---|---|---|---|
| W | M | T1 | T2 |

Upon focusing on infinity

| | | | | |
|---|---|---|---|---|
| Focal | 71.548 | 135.050 | 200.028 | 290.942 |
| length | | | | |
| D0 | ∞ | ∞ | ∞ | ∞ |
| D5 | 1.500 | 27.147 | 41.533 | 41.533 |
| D13 | 41.615 | 15.968 | 1.581 | 1.581 |
| D21 | 1.873 | 2.684 | 1.943 | 18.237 |
| D26 | 24.719 | 19.898 | 17.795 | 1.500 |
| D31 | 6.344 | 6.130 | 11.214 | 12.053 |
| D33 | 8.357 | 6.869 | 2.414 | 1.575 |
| D42 | 17.020 | 18.526 | 16.675 | 2.976 |
| D44 | 12.661 | 16.866 | 20.933 | 34.632 |
| Bf | 11.741 | 11.741 | 11.741 | 11.741 |

Upon focusing on a short-distance object

| | | | | |
|---|---|---|---|---|
| Zoom | −0.205 | −0.147 | −0.165 | −0.100 |
| magnification | | | | |
| D0 | 250.000 | 700.000 | 900.000 | 3000.000 |
| D5 | 1.500 | 27.147 | 41.533 | 41.533 |
| D13 | 41.615 | 15.968 | 1.581 | 1.581 |
| D21 | 2.113 | 2.058 | 1.863 | 18.237 |
| D26 | 24.478 | 20.524 | 17.874 | 1.500 |
| D31 | 2.094 | 1.600 | 3.491 | 3.991 |
| D33 | 12.607 | 11.399 | 10.137 | 9.637 |
| D42 | 23.533 | 28.326 | 31.299 | 4.992 |
| D44 | 6.149 | 7.066 | 6.310 | 32.617 |
| Bf | 11.741 | 11.741 | 11.741 | 11.741 |

[Lens group data]

| | Starting | Focal |
|---|---|---|
| Group | surface | length |
| G1 | 1 | 130.513 |
| G2 | 6 | −45.453 |
| G3 | 14 | 57.730 |
| G4 | 22 | −51.346 |
| G5 | 27 | 97.646 |
| G6 | 32 | 76.219 |
| G7 | 34 | 987.656 |
| G8 | 43 | −71.174 |
| G9 | 45 | 849.550 |

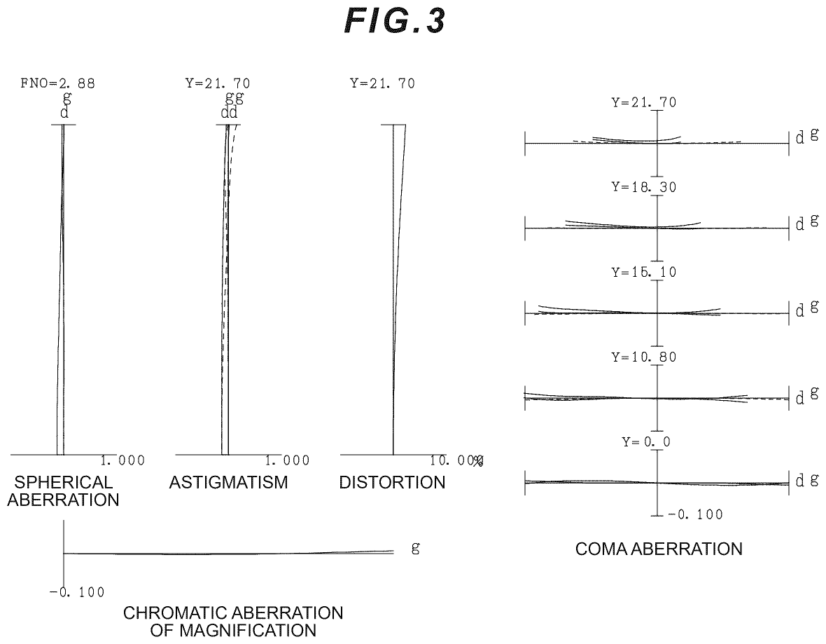

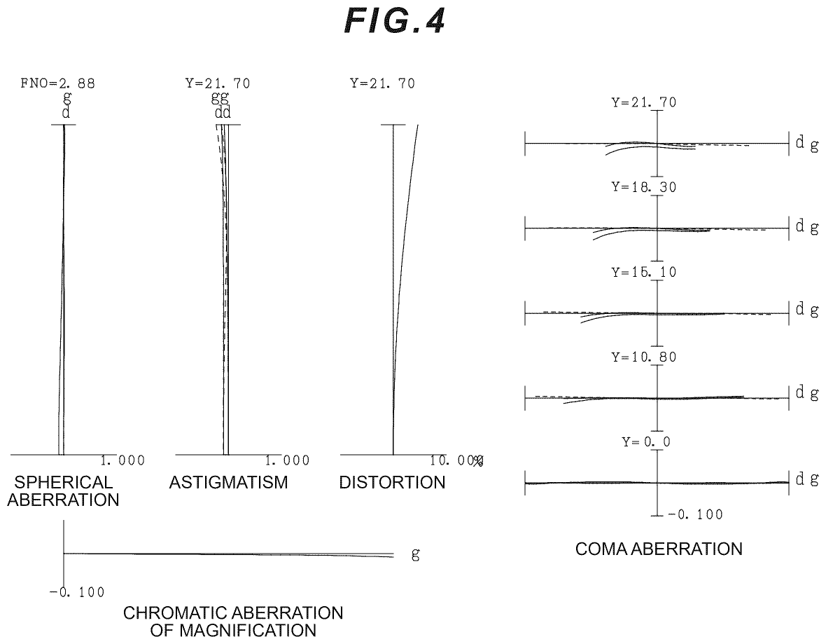

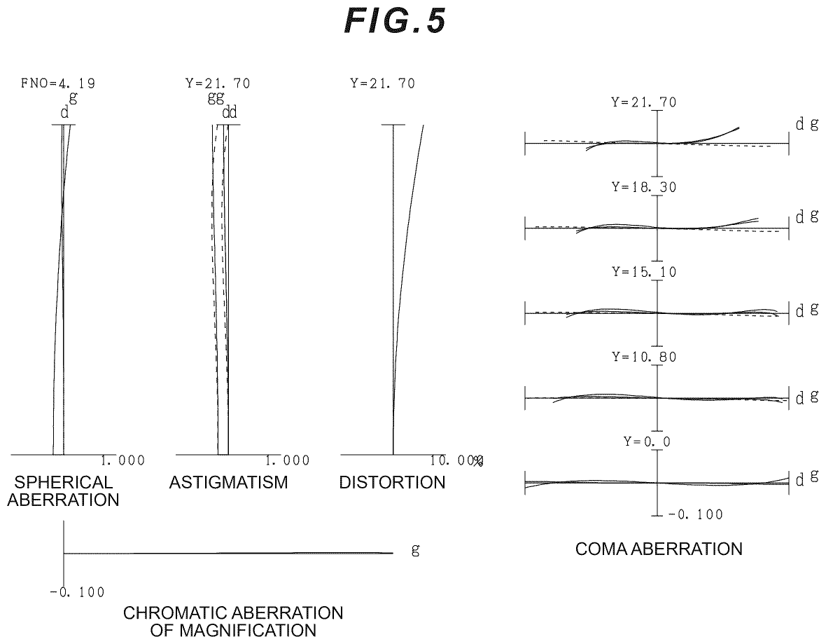

FIG. 3 illustrates graphs showing various aberrations upon focusing on infinity in the wide-angle end state of the zoom optical system according to the first example. FIG. 4 illustrates graphs showing various aberrations upon focusing on infinity in the first telephoto end state of the zoom optical system according to the first example. FIG. 5 illustrates graphs showing various aberrations upon focusing on infinity in the second telephoto end state of the zoom optical system according to the first example. In the aberration graphs, FNO indicates the F-number and Y indicates the image height, respectively. Note that the spherical aberration graphs show a value of the F-number corresponding to a maximum aperture, the astigmatism and distortion graphs each show a maximum value of the image height, respectively. The coma aberration graphs show each image height value. d indicates the d-line (wavelength λ=587.6 nm) and g indicates the g-line (wavelength λ=435.8 nm), respectively. In the astigmatism graphs, a solid line indicates a sagittal image surface and a dashed line indicates a meridional image surface. Note that in the aberration graphs of each example shown hereinafter, the same reference signs are used as in the present example, and overlapping description is omitted.

As is apparent from the graphs showing various aberrations, the zoom optical system according to first example can favorably correct various aberrations from the wide-angle end state to the first telephoto end state and from the first telephoto end state to the second telephoto end state, and has superior image formation performance.

### Second Example

The second example will be described with reference to FIGS. 6 to 10 and Table 2. FIG. 6 is a diagram showing a lens configuration of the zoom optical system according to the second example. The zoom optical system ZL(2) according to the second example comprises, in order from the object along the optical axis, the first lens group G1 having positive refractive power, the second lens group G2 having negative refractive power, the third lens group G3 having positive refractive power, the fourth lens group G4 having negative refractive power, the fifth lens group G5 having positive refractive power, the sixth lens group G6 having positive refractive power, the seventh lens group G7 having negative refractive power, and the eighth lens group G8 having negative refractive power.

When zooming from the wide-angle end state (W) to the first telephoto end state (T1) via the medium focus state (M), the second lens group G2, the fourth lens group G4, the fifth lens group G5, the sixth lens group G6, and the seventh lens group G7 move along the optical axis as indicated by the arrows in FIG. 6, and the distance between each adjacent lens group changes. That is, when zooming from the wide-angle end state to the first telephoto end state, N1=5 lens groups move along the optical axis. Note that when zooming from the wide-angle end state to the first telephoto end state, the first lens group G1, the third lens group G3, and the eighth lens group G8 are fixed relative to the image surface I.

When zooming from the first telephoto end state (T1) to the second telephoto end state (T2), the fourth lens group G4 and the sixth lens group G6 move toward the image surface along the optical axis at different trajectories (movement amounts). That is, when zooming from the first telephoto end state to the second telephoto end state, N2=2 lens groups move along the optical axis. Note that when zooming from the first telephoto end state to the second telephoto end state, the first lens group G1, the second lens group G2, the third lens group G3, the fifth lens group G5, the seventh lens group G7, and the eighth lens group G8 are fixed relative to the image surface I. The aperture stop S is arranged between the third lens group G3 and the fourth lens group G4, and the aperture stop S is fixed relative to the image surface I along with the third lens group G3 when zooming.

The first lens group G1 comprises, in order from the object along the optical axis, the cemented positive lens obtained by cementing together the meniscus-shaped negative lens L11 having a convex surface facing the object and the biconvex positive lens L12, and the meniscus-shaped positive lens L13 having a convex surface facing the object.

The second lens group G2 comprises, in order from the object along the optical axis, the meniscus-shaped negative lens L21 having a convex surface facing the object, the biconcave negative lens L22, the meniscus-shaped positive lens L23 having a convex surface facing the object, and the biconcave negative lens L24. The second lens group G2 is the lens group with the largest movement amount when zooming from the wide-angle end state to the first telephoto end state.

The third lens group G3 comprises, in order from the object along the optical axis, the meniscus-shaped positive lens L31 having a convex surface facing the object, the meniscus-shaped positive lens L32 having a convex surface facing the object, and the cemented positive lens obtained by cementing together the meniscus-shaped negative lens L33 having a convex surface facing the object and the meniscus-shaped positive lens L34 having a convex surface facing the object.

The fourth lens group G4 comprises, in order from the object along the optical axis, a meniscus-shaped negative lens L41 having a convex surface facing the object, and a cemented negative lens obtained by cementing together the biconcave negative lens L42 and the meniscus-shaped positive lens L43 having a convex surface facing the object. The fourth lens group G4 is the lens group with the largest movement amount when zooming from the first telephoto end state to the second telephoto end state.

The fifth lens group G5 comprises, in order from the object along the optical axis, the biconvex positive lens L51, and the cemented positive lens obtained by cementing together the biconvex positive lens L52 and the biconcave negative lens L53. The object-side lens surface of the positive lens L51 is an aspherical surface.

The sixth lens group G6 comprises the biconvex positive lens L61. The sixth lens group G6 is the lens group with the smallest movement amount when zooming from the first telephoto end state to the second telephoto end state.

The seventh lens group G7 comprises, in order from the object along the optical axis, a biconvex positive lens L71, the meniscus-shaped negative lens L72 having a convex surface facing the object, a cemented negative lens obtained by cementing together a meniscus-shaped positive lens L73 having a concave surface facing the object and the biconcave negative lens L74, and the biconvex positive lens L75. The image surface-side lens surface of the meniscus-shaped negative lens L72 is an aspherical surface.

The eighth lens group G8 comprises, in order from the object along the optical axis, the meniscus-shaped negative lens L81 having a concave surface facing the object and a biconvex positive lens L82. The image surface I is arranged on the image side from the eighth lens group G8.

In the present example, the fourth lens group G4, the fifth lens group G5, the sixth lens group G6, the seventh lens group G7, and the eighth lens group G8 constitute the rear group GR. In the rear group GR, the fourth lens group G4 corresponds to the first focus lens group GF1, and the sixth lens group G6 corresponds to the second focus lens group GF2. The eighth lens group G8 corresponds to the final lens group GE.

When focusing from the infinity object to the short-distance object in the wide-angle end state, the medium focal length state, and the second telephoto end state, the first focus lens group GF1 (fourth lens group G4) and the second focus lens group GF2 (sixth lens group G6) move toward the object along the optical axis at different trajectories (movement amounts). When focusing from the infinity object to the short-distance object in the first telephoto end state, only the second focus lens group GF2 (sixth lens group G6) moves toward the object along the optical axis. When zooming from the first telephoto end state to the second telephoto end state, the first focus lens group GF1 (fourth lens group G4) and the second focus lens group GF2 (sixth lens group G6) move toward the image surface along the optical axis at different trajectories (movement amounts).

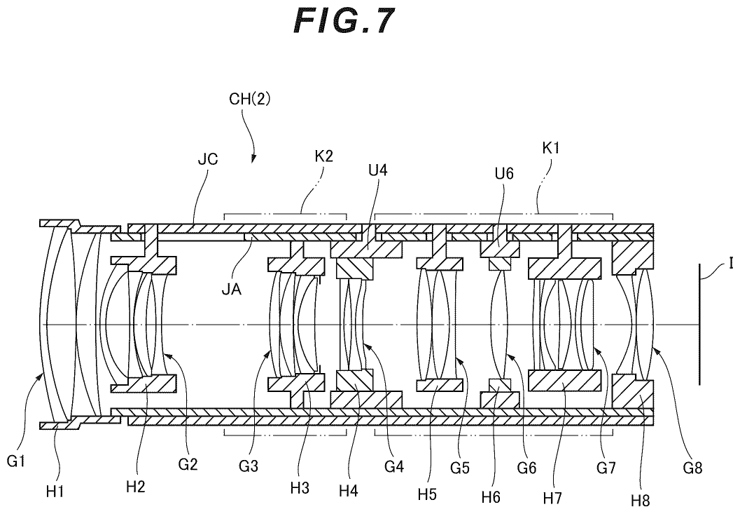

As described above, the zoom optical system ZL(2) according to the second example is provided in the photographic lens 3 (see FIG. 16) attached to the main body 2 of the camera 1. As schematically shown in FIG. 7, the first to eighth group frames H1 to H8, the fixed barrel JA, and the cam barrel JC are built into the photographic lens 3 (lens barrel) as a lens position control mechanism CH(2) according to the second example. The first lens group G1 is held by the first group frame H1. The second lens group G2 is held by the second group frame H2. The third lens group G3 is held by the third group frame H3. The fourth lens group G4 is held by the fourth group frame H4. The fifth lens group G5 is held by the fifth group frame H5. The sixth lens group G6 is held by the sixth group frame H6. The seventh lens group G7 is held by the seventh group frame H7. The eighth lens group G8 is held by the eighth group frame H8.

The cam barrel JC is arranged at the outer circumference side of the fixed barrel JA to be rotatable relative to the fixed barrel JA. The first group frame H1 is fixed to the fixed barrel JA closest to the object. The eighth group frame H8 is fixed to the fixed barrel JA closest to the image surface. The second group frame H2, the third group frame H3, the fourth group barrel member U4, the fifth group frame H5, the sixth group barrel member U6, and the seventh group frame H7 are arranged at the inner side of the fixed barrel JA in order from the object. Note that the third group frame H3 is fixed at the inner side of the fixed barrel JA. The fourth group frame H4 is arranged at the inner side of the fourth group barrel member U4. The sixth group frame H6 is arranged at the inner side of the sixth group barrel member U6. The plurality of guide bars extending along the optical axis direction are provided at the inner circumferential portion of the fixed barrel JA, and engage with the guide grooves of the corresponding lens group frames and barrel members.

The plurality of cam grooves are formed in the cam barrel JC, and the cam followers of the corresponding lens group frames and barrel members engage therewith. As indicated by dash-double-dot lines in FIG. 7, the first operation ring K1 and the second operation ring K2 are provided at the outer circumference side of the cam barrel JC so as to be rotatable relative to the fixed barrel JA. The first operation ring K1 and the second operation ring K2 have the same configuration as the first operation ring K1 and the second operation ring K2 according to the first example, and detailed description thereof is omitted.

The fourth group drive unit (not shown) is provided at the fourth group barrel member U4. The fourth group drive unit drives the fourth group frame H4 in the optical axis direction. The sixth group drive unit (not shown) is provided at the sixth group barrel member U6. The sixth group drive unit drives the sixth group frame H6 in the optical axis direction. The fourth group drive unit and the sixth group drive unit have the same configuration as the fourth group drive unit and the sixth group drive unit according to the first example, and detailed description thereof is omitted.

When zooming from the wide-angle end state to the first telephoto end state, the second group frame H2, the fourth group barrel member U4, the fifth group frame H5, the sixth group barrel member U6, and the seventh group frame H7 are driven in the optical axis direction through the rotation of the cam barrel JC that rotates via the rotation of the first operation ring K1. When zooming from the first telephoto end state to the second telephoto end state or when focusing, the fourth group frame H4 is driven in the optical axis direction relative to the fourth group barrel member U4 by the fourth group drive unit (not shown) provided at the fourth group barrel member U4 in accordance with the rotation of the first operation ring K1 or the second operation ring K2. The sixth group frame H6 is also driven in the optical axis direction relative to the sixth group barrel member U6 by the sixth group drive unit (not shown) provided at the sixth group barrel member U6 in accordance with the rotation of the first operation ring K1 or the second operation ring K2.

That is, the second lens group G2, the fifth lens group G5, and the seventh lens group G7 are mechanically driven in the optical axis direction when the first operation ring K1 is rotated. The fourth lens group G4 and the sixth lens group G6 are driven mechanically and electrically (motor drive control) in the optical axis direction when the first operation ring K1 is rotated, and driven electrically in the optical axis direction when the second operation ring K2 is rotated and a focus operation is instructed.

In this way, the second lens group G2, the fourth lens group G4, the fifth lens group G5, the sixth lens group G6, and the seventh lens group G7 are driven in the optical axis direction when zooming from the wide-angle end state to the first telephoto end state. The fourth lens group G4 and the sixth lens group G6 are driven in the optical axis direction when zooming from the first telephoto end state to the second telephoto end state. The fourth lens group G4 and the sixth lens group G6 are driven in the optical axis direction when focusing. In the present example, the fourth lens group G4 and the sixth lens group G6 are not limited to being driven mechanically and electrically (motor drive control), and may be driven electrically in the optical axis direction. The second lens group G2, the fifth lens group G5, and the seventh lens group G7 are not limited to being driven mechanically, and may be driven electrically in the optical axis direction.

Data values of the zoom optical system according to the second example are listed in the following Table 2.

TABLE 2
[General Data]

| Zooming ratio | Zooming ratio |
|---|---|
| (WT→1) = 2.796 | (W→T2) = 4.066 |
| MA = 39.241 | MB = 19.056 |
| MC = 1.585 | MG2 = 39.241 |
| D23 = 39.241 | |
| MF1w = 5.842 | MF1t = 19.056 |
| MF2w = 8.376 | MF2t = 1.585 |

| | W | M | T1 | T2 |
|---|---|---|---|---|
| f | 71.533 | 135.021 | 199.988 | 290.888 |
| FNO | 2.880 | 2.880 | 2.880 | 4.190 |
| ω | 16.505 | 8.743 | 5.900 | 4.061 |
| Y | 21.700 | 21.700 | 21.700 | 21.700 |
| TL | 250.011 | 250.011 | 250.011 | 250.011 |
| Bf | 17.789 | 17.789 | 17.789 | 17.789 |

[Lens Data]

| Surface | | | | |
|---|---|---|---|---|
| number | R | D | nd | νd |
| 1 | 114.544 | 2.800 | 2.00100 | 29.12 |
| 2 | 83.656 | 10.935 | 1.43700 | 95.10 |
| 3 | −325.490 | 0.100 | | |
| 4 | 76.421 | 7.548 | 1.49782 | 82.57 |
| 5 | 301.176 | (D5) | | |
| 6 | 42.823 | 2.000 | 1.80420 | 46.50 |
| 7 | 27.561 | 9.202 | | |
| 8 | −421.746 | 1.800 | 1.59282 | 68.62 |
| 9 | 55.874 | 0.100 | | |
| 10 | 37.770 | 4.827 | 1.78880 | 28.43 |
| 11 | 101.335 | 3.721 | | |
| 12 | −78.344 | 1.781 | 1.59282 | 68.62 |
| 13 | 78.190 | (D13) | | |
| 14 | 77.705 | 3.571 | 1.84666 | 23.80 |
| 15 | 360.519 | 0.100 | | |
| 16 | 40.850 | 5.243 | 1.59282 | 68.62 |
| 17 | 212.184 | 0.100 | | |
| 18 | 66.204 | 1.728 | 2.00100 | 29.12 |
| 19 | 26.080 | 6.325 | 1.59282 | 68.62 |
| 20 | 129.745 | 2.463 | | |
| 21 | ∞ | (D21) | | (Aperture |
| | | | | Stop) |
| 22 | 862.907 | 1.523 | 1.51860 | 69.89 |
| 23 | 86.284 | 2.756 | | |
| 24 | −83.791 | 1.498 | 1.72916 | 54.61 |
| 25 | 59.685 | 2.642 | 1.95906 | 17.47 |
| 26 | 103.445 | (D26) | | |
| 27* | 98.633 | 6.161 | 1.72916 | 54.68 |
| 28 | −77.363 | 0.100 | | |
| 29 | 114.635 | 6.339 | 1.55032 | 75.50 |
| 30 | −67.817 | 1.943 | 1.85451 | 25.15 |
| 31 | 389.754 | (D31) | | |
| 32 | 54.843 | 6.404 | 1.59282 | 68.62 |
| 33 | −147.636 | (D33) | | |
| 34 | 222.852 | 2.429 | 1.71300 | 53.87 |
| 35 | −1960.235 | 0.100 | | |
| 36 | 82.264 | 1.500 | 1.91082 | 35.25 |
| 37* | 30.467 | 5.759 | | |
| 38 | −459.309 | 4.400 | 2.00100 | 29.12 |
| 39 | −45.938 | 1.599 | 1.81600 | 46.62 |
| 40 | 54.968 | 2.000 | | |
| 41 | 45.009 | 5.060 | 1.68948 | 31.02 |
| 42 | −473.780 | (D42) | | |
| 43 | −29.972 | 1.625 | 1.95375 | 32.33 |
| 44 | −103.892 | 0.100 | | |
| 45 | 78.373 | 6.295 | 1.62004 | 36.30 |
| 46 | −97.421 | Bf | | |

[Aspherical surface data]
27th surface
κ = 1.000, A4 = −2.00672E−06, A6 = 2.68755E−10, A8 = −3.53434E−13,
A10 = 2.25579E−16
37th surface
κ = 1.000, A4 = −6.78662E−07, A6 = −6.07215E−10, A8 = −3.52567E−13,
A10 = 6.36352E−16

[Variable distance data]

| | | | |
|---|---|---|---|
| W | M | T1 | T2 |

Upon focusing on infinity

| | | | | |
|---|---|---|---|---|
| Focal | 71.533 | 135.021 | 199.988 | 290.888 |
| length | | | | |
| D0 | ∞ | ∞ | ∞ | ∞ |
| D5 | 1.500 | 28.444 | 40.741 | 40.741 |
| D13 | 40.741 | 13.797 | 1.500 | 1.500 |
| D21 | 7.342 | 5.711 | 1.500 | 20.556 |
| D26 | 20.555 | 21.704 | 20.556 | 1.500 |
| D31 | 13.313 | 7.408 | 10.778 | 12.363 |
| D33 | 9.991 | 8.837 | 3.084 | 1.499 |
| D42 | 14.203 | 21.743 | 29.486 | 29.486 |
| Bf | 17.789 | 17.789 | 17.789 | 17.789 |

Upon focusing on a short-distance object

| | | | | |
|---|---|---|---|---|
| Zoom | −0.199 | −0.139 | −0.174 | −0.096 |
| magnification | | | | |
| D0 | 250.000 | 700.000 | 900.000 | 3000.000 |
| D5 | 1.500 | 28.444 | 40.741 | 40.741 |
| D13 | 40.741 | 13.797 | 1.500 | 1.500 |
| D21 | 5.071 | 1.500 | 1.500 | 19.783 |
| D26 | 22.826 | 25.916 | 20.556 | 2.273 |
| D31 | 9.035 | 2.906 | 1.492 | 4.633 |
| D33 | 14.269 | 13.340 | 12.370 | 9.229 |
| D42 | 14.203 | 21.743 | 29.486 | 29.486 |
| Bf | 17.789 | 17.789 | 17.789 | 17.789 |

[Lens group data]

| | Starting | Focal |
|---|---|---|
| Group | surface | length |
| G1 | 1 | 122.121 |
| G2 | 6 | −39.013 |
| G3 | 14 | 60.126 |
| G4 | 22 | −50.190 |
| G5 | 27 | 65.085 |
| G6 | 32 | 68.258 |
| G7 | 34 | −105.133 |
| G8 | 43 | −135.867 |

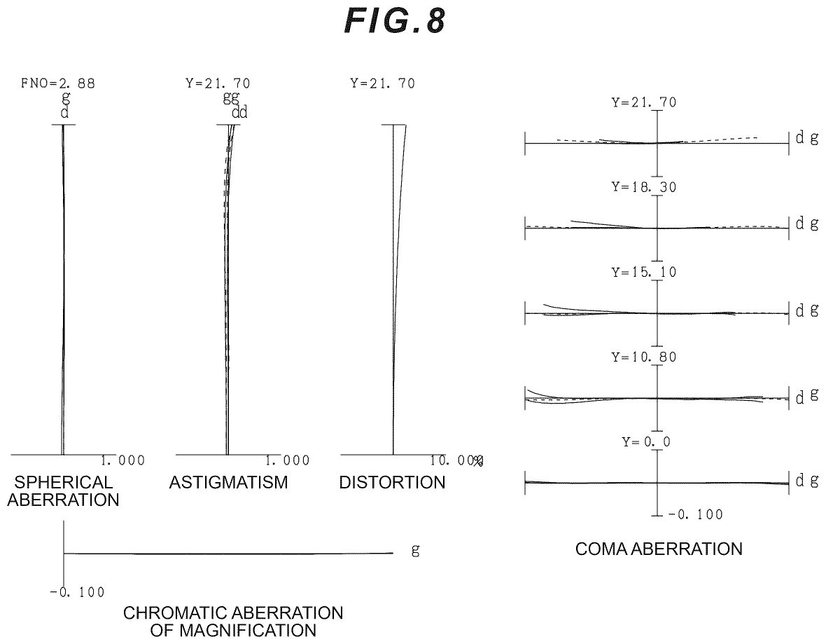

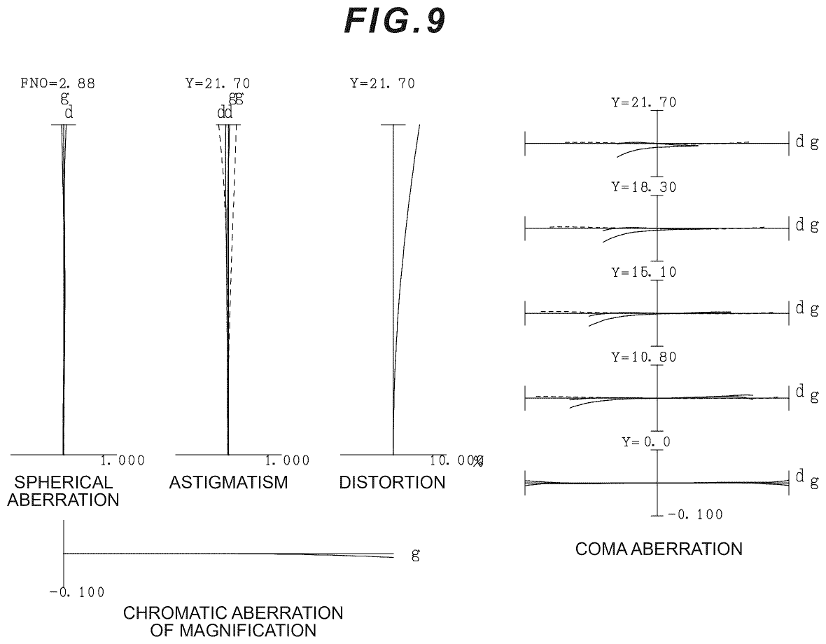

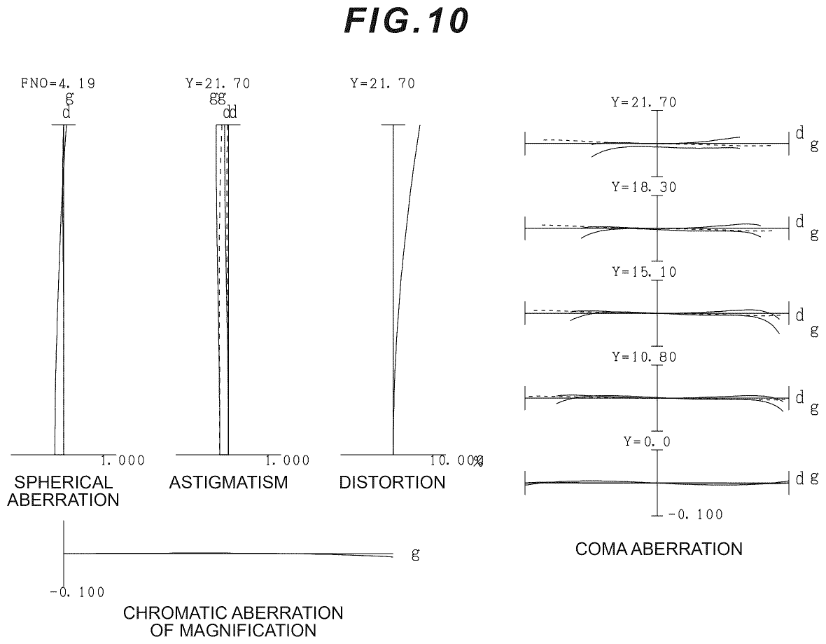

FIG. 8 illustrates graphs showing various aberrations upon focusing on infinity in the wide-angle end state of the zoom optical system according to the second example. FIG. 9 illustrates graphs showing various aberrations upon focusing on infinity in the first telephoto end state of the zoom optical system according to the second example. FIG. 10 illustrates graphs showing various aberrations upon focusing on infinity in the second telephoto end state of the zoom optical system according to the second example.

As is apparent from the graphs showing various aberrations, the zoom optical system according to second example can favorably correct various aberrations from the wide-angle end state to the first telephoto end state and from the first telephoto end state to the second telephoto end state, and has superior image formation performance.

### Third Example

The third example will be described with reference to FIGS. 11 to 15 and Table 3. FIG. 11 is a diagram showing a lens configuration of the zoom optical system according to the third example. The zoom optical system ZL(3) according to the third example comprises, in order from the object along the optical axis, the first lens group G1 having positive refractive power, the second lens group G2 having negative refractive power, the third lens group G3 having positive refractive power, the fourth lens group G4 having negative refractive power, the fifth lens group G5 having negative refractive power, the sixth lens group G6 having positive refractive power, the seventh lens group G7 having positive refractive power, the eighth lens group G8 having negative refractive power, and the ninth lens group G9 having negative refractive power.

When zooming from the wide-angle end state (W) to the first telephoto end state (T1) via the medium focus state (M), the second lens group G2, the third lens group G3, the fifth lens group G5, the sixth lens group G6, the seventh lens group G7, and the eighth lens group G8 move along the optical axis as indicated by the arrows in FIG. 11, and the distance between each adjacent lens group changes. That is, when zooming from the wide-angle end state to the first telephoto end state, N1=6 lens groups move along the optical axis. Note that when zooming from the wide-angle end state to the first telephoto end state, the first lens group G1, the fourth lens group G4, and the ninth lens group G9 are fixed relative to the image surface I.

When zooming from the first telephoto end state (T1) to the second telephoto end state (T2), the fifth lens group G5 and the seventh lens group G7 move toward the image surface along the optical axis at different trajectories (movement amounts). That is, when zooming from the first telephoto end state to the second telephoto end state, N2=2 lens groups move along the optical axis. Note that when zooming from the first telephoto end state to the second telephoto end state, the first lens group G1, the second lens group G2, the third lens group G3, the fourth lens group G4, the sixth lens group G6, the eighth lens group G8, and the ninth lens group G9 are fixed relative to the image surface I. The aperture stop S is arranged between the third lens group G3 and the fourth lens group G4, and the aperture stop S is fixed relative to the image surface I along with the fourth lens group G4 when zooming.

The first lens group G1 comprises, in order from the object along the optical axis, the cemented positive lens obtained by cementing together the meniscus-shaped negative lens L11 having a convex surface facing the object and the biconvex positive lens L12, and the meniscus-shaped positive lens L13 having a convex surface facing the object.

The second lens group G2 comprises, in order from the object along the optical axis, the meniscus-shaped negative lens L21 having a convex surface facing the object, the biconcave negative lens L22, the meniscus-shaped positive lens L23 having a convex surface facing the object, and the biconcave negative lens L24. The second lens group G2 is the lens group with the largest movement amount when zooming from the wide-angle end state to the first telephoto end state.

The third lens group G3 comprises, in order from the object along the optical axis, a biconvex positive lens L31 and the meniscus-shaped positive lens L32 having a convex surface facing the object.

The fourth lens group G4 comprises, in order from the object along the optical axis, a cemented negative lens obtained by cementing together the meniscus-shaped negative lens L41 having a convex surface facing the object and a meniscus-shaped positive lens L42 having a convex surface facing the object.

The fifth lens group G5 comprises, in order from the object along the optical axis, a biconcave negative lens L51, a meniscus-shaped negative lens L52 having a convex surface facing the object, and a meniscus-shaped positive lens L53 having a convex surface facing the object. The fifth lens group G5 is the lens group with the largest movement amount when zooming from the first telephoto end state to the second telephoto end state.

The sixth lens group G6 comprises, in order from the object along the optical axis, a biconvex positive lens L61, and a cemented positive lens obtained by cementing together a meniscus-shaped negative lens L62 having a convex surface facing the object and a biconvex positive lens L63.

The seventh lens group G7 comprises a meniscus-shaped positive lens L71 having a convex surface facing the object. The seventh lens group G7 is the lens group with the smallest movement amount when zooming from the first telephoto end state to the second telephoto end state.

The eighth lens group G8 comprises, in order from the object along the optical axis, a meniscus-shaped negative lens L81 having a convex surface facing the object and the biconvex positive lens L82. An object-side lens surface of the meniscus-shaped negative lens L81 is an aspherical surface.

The ninth lens group G9 comprises, in order from the object along the optical axis, the meniscus-shaped negative lens L91 having a concave surface facing the object and the biconvex positive lens L92. An object-side lens surface of the meniscus-shaped negative lens L91 is an aspherical surface. The image surface I is arranged on the image side from the ninth lens group G9.

In the present example, the fourth lens group G4, the fifth lens group G5, the sixth lens group G6, the seventh lens group G7, the eighth lens group G8, and the ninth lens group G9 constitute the rear group GR. In the rear group GR, the fifth lens group G5 corresponds to the first focus lens group GF1, and the seventh lens group G7 corresponds to the second focus lens group GF2. The ninth lens group G9 corresponds to the final lens group GE.

When focusing from the infinity object to the short-distance object in the wide-angle end state, the medium focal length state, and the first telephoto end state, the first focus lens group

GF1 (fifth lens group G5) and the second focus lens group GF2 (seventh lens group G7) move toward the object along the optical axis at different trajectories (movement amounts). When focusing from the infinity object to the short-distance object in the second telephoto end state, only the second focus lens group GF2 (seventh lens group G7) moves toward the object along the optical axis. When zooming from the first telephoto end state to the second telephoto end state, the first focus lens group GF1 (fifth lens group G5) and the second focus lens group GF2 (seventh lens group G7) move toward the image surface along the optical axis at different trajectories (movement amounts).

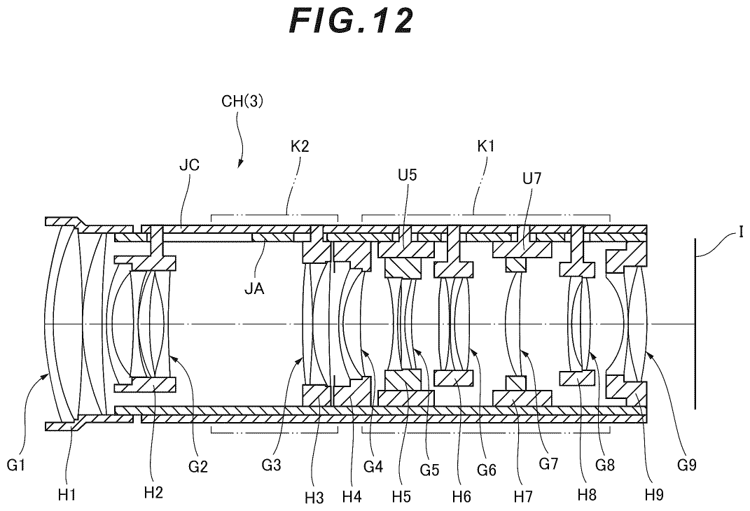

As described above, the zoom optical system ZL(3) according to the third example is provided in the photographic lens 3 (see FIG. 16) attached to the main body 2 of the camera 1. As schematically shown in FIG. 12, the first to ninth group frames H1 to H9, the fixed barrel JA, and the cam barrel JC are built into the photographic lens 3 (lens barrel) as a lens position control mechanism CH(3) according to the third example. The first lens group G1 is held by the first group frame H1. The second lens group G2 is held by the second group frame H2. The third lens group G3 is held by the third group frame H3. The fourth lens group G4 is held by the fourth group frame H4. The fifth lens group G5 is held by the fifth group frame H5. The sixth lens group G6 is held by the sixth group frame H6. The seventh lens group G7 is held by the seventh group frame H7. The eighth lens group G8 is held by the eighth group frame H8. The ninth lens group G9 is held by the ninth group frame H9.

The cam barrel JC is arranged at the outer circumference side of the fixed barrel JA to be rotatable relative to the fixed barrel JA. The first group frame H1 is fixed to the fixed barrel JA closest to the object. The ninth group frame H9 is fixed to the fixed barrel JA closest to the image surface. The second group frame H2, the third group frame H3, the fourth group frame H4, a fifth group barrel member U5, the sixth group frame H6, a seventh group barrel member U7, and the eighth group frame H8 are arranged at the inner side of the fixed barrel JA in order from the object. Note that the fourth group frame H4 is fixed at the inner side of the fixed barrel JA. The fifth group frame H5 is arranged on an inner side of the fifth group barrel member U5. The seventh group frame H7 is arranged on an inner side of the seventh group barrel member U7. The plurality of guide bars extending along the optical axis direction are provided at the inner circumferential portion of the fixed barrel JA, and engage with the guide grooves of the corresponding lens group frames and barrel members.

The plurality of cam grooves are formed in the cam barrel JC, and the cam followers of the corresponding lens group frames, barrel members, or the like engage therewith. As indicated by the dash-double-dot lines in FIG. 2, the first operation ring K1 and the second operation ring K2 are provided at the outer circumference side of the cam barrel JC so as to be rotatable relative to the fixed barrel JA. The first operation ring K1 and the second operation ring K2 have the same configuration as the first operation ring K1 and the second operation ring K2 according to the first example, and detailed description thereof is omitted.

A fifth group drive unit (not shown) is provided at the fifth group barrel member U5. The fifth group drive unit drives the fifth group frame H5 in the optical axis direction. The fifth group drive unit can drive the fifth lens group G5 (first focus lens group GF1) held by the fifth group frame H5 in the optical axis direction not only when focusing but also when zooming from the first telephoto end state to the second telephoto end state. For example, the fifth group drive unit includes a fifth group drive motor (not shown), a fifth group lead screw (not shown), and a fifth group rack (not shown). The fifth group drive motor is, for example, a stepping motor and is fixed to the fifth group barrel member U5. The fifth group lead screw includes a threaded portion, is formed in a shaft shape extending in the optical axis direction, and is connected to an output shaft of the fifth group drive motor to rotate. The fifth group rack engages with the threaded portion of the fifth group lead screw and is connected to the fifth group frame H5. Note that a drive mechanism for driving the fifth group frame H5 in the optical axis direction can be modified as necessary.

A seventh group drive unit (not shown) is provided at the seventh group barrel member U7. The seventh group drive unit drives the seventh group frame H7 in the optical axis direction. The seventh group drive unit can drive the seventh lens group G7 (second focus lens group GF2) held by the seventh group frame H7 in the optical axis direction not only when focusing but also when zooming from the first telephoto end state to the second telephoto end state. For example, the seventh group drive unit includes a seventh group drive motor (not shown), a seventh group lead screw (not shown), and a seventh group rack (not shown). The seventh group drive motor is, for example, a stepping motor and is fixed to the seventh group barrel member U6. The seventh group lead screw includes a threaded portion, is formed in a shaft shape extending in the optical axis direction, and is connected to an output shaft of the seventh group drive motor to rotate. The seventh group rack engages with the threaded portion of the seventh group lead screw and is connected to the seventh group frame H7. Note that a drive mechanism for driving the seventh group frame H7 in the optical axis direction can be modified as necessary.

When zooming from the wide-angle end state to the first telephoto end state, the second group frame H2, the third group frame H3, the fifth group barrel member U5, the sixth group frame H6, the seventh group barrel member U7, and the eighth group frame H8 are driven in the optical axis direction through the rotation of the cam barrel JC that rotates via the rotation of the first operation ring K1. When zooming from the first telephoto end state to the second telephoto end state or when focusing, the fifth group frame H5 is driven in the optical axis direction relative to the fifth group barrel member U5 by the fifth group drive unit (not shown) provided at the fifth group barrel member U5 in accordance with the rotation of the first operation ring K1 or the second operation ring K2. The seventh group frame H7 is also driven in the optical axis direction relative to the seventh group barrel member U7 by the seventh group drive unit (not shown) provided at the seventh group barrel member U7 in accordance with the rotation of the first operation ring K1 or the second operation ring K2.

That is, the second lens group G2, the third lens group G3, the sixth lens group G6, and the eighth lens group G8 are mechanically driven in the optical axis direction when the first operation ring K1 is rotated. Also, the fifth lens group G5 and the seventh lens group G7 are driven mechanically and electrically (motor drive control) in the optical axis direction when the first operation ring K1 is rotated, and driven electrically in the optical axis direction when the second operation ring K2 is rotated and a focus operation is instructed.

In this way, the second lens group G2, the third lens group G3, the fifth lens group G5, the sixth lens group G6, the seventh lens group G7, and the eighth lens group G8 are driven in the optical axis direction when zooming from the wide-angle end state to the first telephoto end state. Furthermore, the fifth lens group G5 and the seventh lens group G7 are driven in the optical axis direction when zooming from the first telephoto end state to the second telephoto end state. Also, the fifth lens group G5 and the seventh lens group G7 are driven in the optical axis direction when focusing. In the present example, the fifth lens group G5 and the seventh lens group G7 are not limited to being driven mechanically and electrically (motor drive control), and may be driven electrically in the optical axis direction. The second lens group G2, the third lens group G3, the sixth lens group G6, and the eighth lens group G8 are not limited to being driven mechanically, and may be driven electrically in the optical axis direction.

Data values of the zoom optical system according to the third example are listed in the following Table 3.

TABLE 3
[General Data]

| Zooming ratio | Zooming ratio |
|---|---|
| (WT→1) = 2.727 | (W→T2) = 3.794 |
| MA = 37.059 | MB = 15.653 |
| MC = 11.656 | MG2 = 37.059 |
| D23 = 47.981 | |
| MF1w = 8.557 | MF1t = 15.653 |
| MF2w = 3.075 | MF2t = 11.656 |

| | W | M | T1 | T2 |
|---|---|---|---|---|
| f | 71.500 | 135.000 | 195.000 | 271.250 |
| FNO | 2.880 | 2.880 | 2.880 | 4.008 |
| ω | 16.747 | 8.797 | 6.050 | 4.326 |
| Y | 21.700 | 21.700 | 21.700 | 21.700 |
| TL | 239.978 | 239.978 | 239.978 | 239.978 |
| Bf | 17.810 | 17.810 | 17.810 | 17.810 |

[Lens Data]

| Surface | | | | |
|---|---|---|---|---|
| number | R | D | nd | νd |
| 1 | 109.659 | 2.800 | 1.92286 | 20.88 |
| 2 | 82.271 | 10.842 | 1.43700 | 95.10 |
| 3 | −330.813 | 0.100 | | |
| 4 | 78.131 | 7.122 | 1.49782 | 82.57 |
| 5 | 307.441 | (D5) | | |
| 6 | 51.751 | 2.000 | 1.83481 | 42.73 |
| 7 | 28.594 | 8.150 | | |
| 8 | −139.801 | 1.800 | 1.48749 | 70.32 |
| 9 | 65.177 | 0.100 | | |
| 10 | 43.822 | 4.076 | 1.92286 | 20.88 |
| 11 | 95.164 | 5.111 | | |
| 12 | −50.633 | 1.800 | 1.48749 | 70.32 |
| 13 | 317.698 | (D13) | | |
| 14 | 188.326 | 3.760 | 1.83481 | 42.73 |
| 15 | −250.346 | 0.100 | | |
| 16 | 47.444 | 5.947 | 1.49782 | 82.57 |
| 17 | 363.047 | (D17) | | |
| 18 | ∞ | 1.500 | | (Aperture |
| | | | | Stop) |
| 19 | 48.849 | 1.853 | 2.00100 | 29.12 |
| 20 | 29.628 | 6.234 | 1.49782 | 82.57 |
| 21 | 124.040 | (D21) | | |
| 22 | −65.827 | 1.439 | 1.48749 | 70.32 |
| 23 | 70.507 | 1.322 | | |
| 24 | 447.716 | 1.418 | 1.83481 | 42.73 |
| 25 | 54.050 | 0.100 | | |
| 26 | 50.831 | 2.687 | 1.92286 | 20.88 |
| 27 | 87.988 | (D27) | | |
| 28 | 196.668 | 4.089 | 1.59319 | 67.90 |
| 29 | −74.796 | 0.100 | | |
| 30 | 87.236 | 1.550 | 2.00100 | 29.12 |
| 31 | 41.918 | 5.718 | 1.49782 | 82.57 |
| 32 | −134.651 | (D32) | | |
| 33 | 42.183 | 5.228 | 1.59319 | 67.90 |
| 34 | 267.553 | (D34) | | |
| 35* | 159.982 | 1.600 | 1.85108 | 40.12 |
| 36 | 34.158 | 3.067 | | |
| 37 | 164.439 | 3.840 | 1.80518 | 25.45 |
| 38 | −93.492 | (D38) | | |
| 39* | −24.902 | 1.551 | 1.85108 | 40.12 |
| 40 | −94.419 | 0.100 | | |
| 41 | 66.664 | 6.668 | 1.61293 | 36.95 |
| 42 | −101.262 | Bf | | |

[Aspherical surface data]
35th surface
κ = 1.000, A4 = 4.10175E−06, A6 = 1.87631E−10, A8 = 1.07919E−12,
A10 = 0.00000E+00
39th surface
κ = 1.000, A4 = 1.01290E−06, A6 = −7.68488E−09, A8 = 3.60877E−11,
A10 = −8.29554E−14

[Variable distance data]

| | | | |
|---|---|---|---|
| W | M | T1 | T2 |

Upon focusing on infinity

| | | | | |
|---|---|---|---|---|
| Focal | 71.500 | 135.000 | 195.000 | 271.250 |
| length | | | | |
| D0 | ∞ | ∞ | ∞ | ∞ |
| D5 | 1.500 | 23.225 | 38.559 | 38.559 |
| D13 | 49.481 | 24.746 | 1.500 | 1.500 |
| D17 | 2.008 | 5.018 | 12.929 | 12.929 |
| D21 | 12.289 | 17.413 | 3.733 | 19.387 |
| D27 | 9.729 | 6.501 | 17.742 | 2.088 |
| D32 | 12.904 | 11.199 | 16.523 | 28.180 |
| D34 | 18.149 | 18.464 | 13.189 | 1.533 |
| D38 | 12.336 | 11.828 | 14.222 | 14.222 |
| Bf | 17.810 | 17.810 | 17.810 | 17.810 |

Upon focusing on a short-distance object

| | | | | |
|---|---|---|---|---|
| Zoom | −0.199 | −0.130 | −0.165 | −0.087 |
| magnification | | | | |
| D0 | 250.000 | 700.000 | 900.000 | 3000.000 |
| D5 | 1.500 | 23.225 | 38.559 | 38.559 |
| D13 | 49.481 | 24.746 | 1.500 | 1.500 |
| D17 | 2.008 | 5.018 | 12.929 | 12.929 |
| D21 | 8.548 | 7.647 | 3.319 | 19.387 |
| D27 | 13.470 | 16.268 | 18.156 | 2.088 |
| D32 | 5.534 | 1.883 | 1.473 | 15.192 |
| D34 | 25.519 | 27.780 | 28.240 | 14.520 |
| D38 | 12.336 | 11.828 | 14.222 | 14.222 |
| Bf | 17.810 | 17.810 | 17.810 | 17.810 |

[Lens group data]

| | Starting | Focal |
|---|---|---|
| Group | surface | length |
| G1 | 1 | 117.117 |
| G2 | 6 | −39.745 |
| G3 | 14 | 59.286 |
| G4 | 19 | −23380.000 |
| G5 | 22 | −48.470 |
| G6 | 28 | 71.329 |
| G7 | 33 | 83.699 |
| G8 | 35 | −201.391 |
| G9 | 39 | −113.675 |

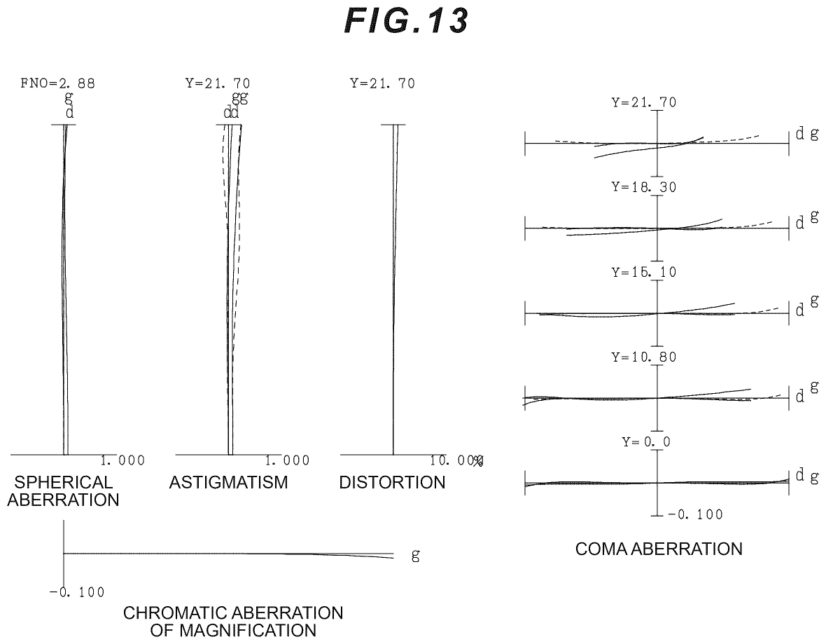

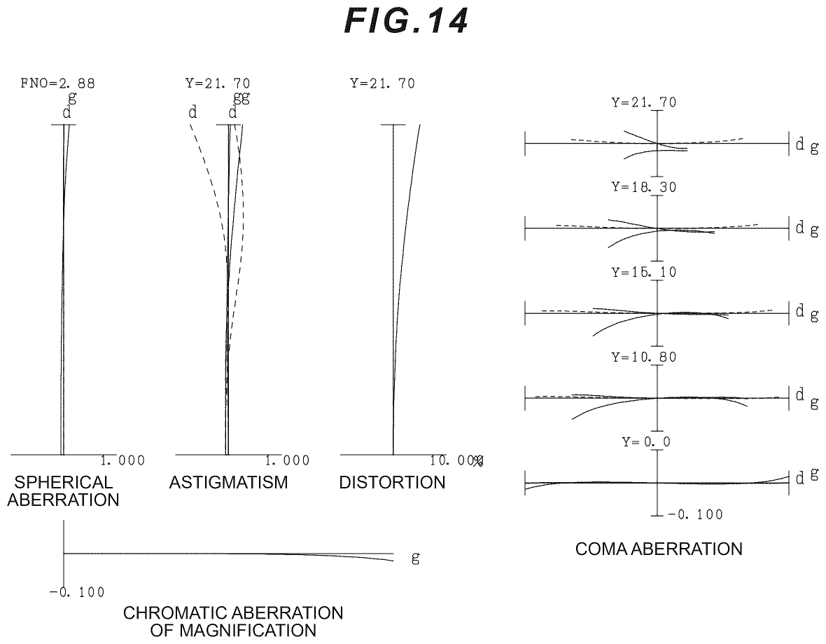

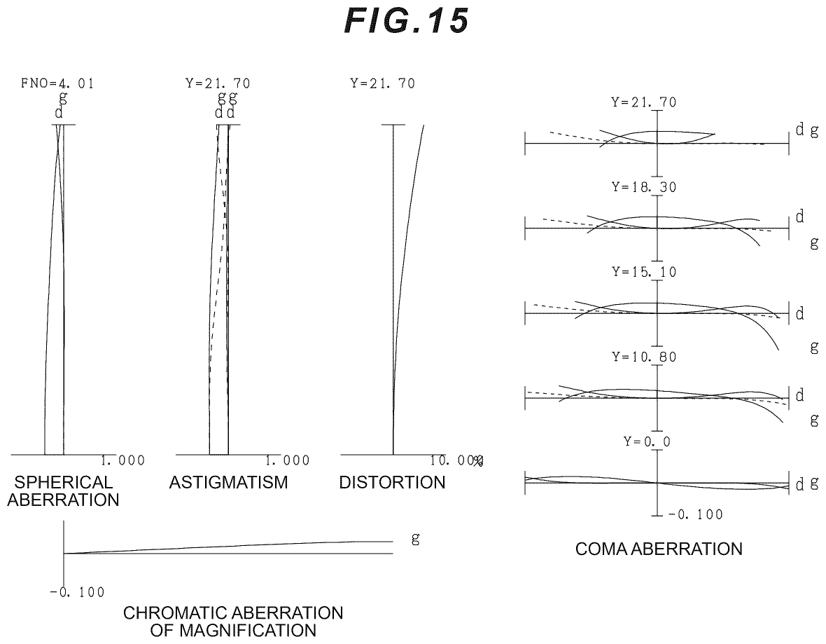

FIG. 13 illustrates graphs showing various aberrations upon focusing on infinity in the wide-angle end state of the zoom optical system according to the third example. FIG. 14 illustrates graphs showing various aberrations upon focusing on infinity in the first telephoto end state of the zoom optical system according to the third example. FIG. 15 illustrates graphs showing various aberrations upon focusing on infinity in the second telephoto end state of the zoom optical system according to the third example. As is apparent from the graphs showing various aberrations, the zoom optical system according to third example can favorably correct various aberrations from the wide-angle end state to the first telephoto end state and from the first telephoto end state to the second telephoto end state, and has superior image formation performance.

Next, a “Conditional Expression Corresponding Value” table is shown below. This table summarizes values corresponding to the conditional expressions (1) to (17) for all of the examples (first to third examples).

0.10<MB/MA<2.00 Conditional expression (1)

ft1/ft2<0.95 Conditional expression (2)

0.75<MG2/(−f2)<1.30 Conditional expression (3)

0.01<Bft2/ft2<0.30 Conditional expression (4)

0.75<D23/(−f2)<1.40 Conditional expression (5)

0.45<D23/f3<1.00 Conditional expression (6)

0<MF1w/MF1t<1.00 Conditional expression (7)

0.05<MF2w/MF2t<10.00 Conditional expression (8)

0.01<MC/MB<2.00 Conditional expression (9)

0.10<Bft2/MB<5.00 Conditional expression (10)

0.05<(−f2)/f1<1.00 Conditional expression (11)

0.01<Bfw/fw<0.50 Conditional expression (12)

2.00<TLw/fw<6.00 Conditional expression (13)

0.01<(−f2)/f3<2.00 Conditional expression (14)

1.80<f1/f3<2.50 Conditional Expression (15)

0.01<|fr1/fr|<5.00 Conditional expression (16)

0.10<f2/fr1<0.75 Conditional expression (17)

### [Conditional Expression Corresponding Value] Example) (First to Third

| Conditional | First | Second | Third |
|---|---|---|---|
| Expression | example | example | example |
| (1) | 0.407 | 0.486 | 0.422 |
| (2) | 0.688 | 0.688 | 0.719 |
| (3) | 0.881 | 1.006 | 0.932 |
| (4) | 0.040 | 0.061 | 0.066 |
| (5) | 0.881 | 1.006 | 1.207 |
| (6) | 0.693 | 0.653 | 0.809 |
| (7) | 0.0043 | 0.3066 | 0.5467 |
| (8) | 2.366 | 5.285 | 0.264 |
| (9) | 0.051 | 0.083 | 0.745 |
| (10) | 0.721 | 0.933 | 1.138 |
| (11) | 0.348 | 0.319 | 0.339 |
| (12) | 0.164 | 0.249 | 0.249 |
| (13) | 3.495 | 3.495 | 3.356 |
| (14) | 0.787 | 0.649 | 0.670 |
| (15) | 2.261 | 2.031 | 1.975 |
| (16) | 0.084 | 0.774 | 1.772 |
| (17) | 0.639 | 0.371 | 0.197 |

According to each of the above examples, it is possible to realize a zoom optical system having bright and favorable optical performance while being compact.

Each of the above examples is a specific example of the present invention, and the present invention is not limited thereto.

The contents described below can be adopted properly without impairing the optical performance of the zoom optical system of each embodiment.

An 8-group configuration and a 9-group configuration are shown as examples of the zoom optical system of each embodiment, but the present application is not limited thereto, and the zoom optical system can also have another group configurations (for example, 10-group, 11-group, 12-group, or the like). For example, a configuration may be used in which a lens or a lens group is added to the zoom optical system of each embodiment closest to the object or the image surface. Also, for example, a configuration may be used in which a lens or a lens group is added to the rear group in the zoom optical system of each embodiment closest to the object or the image surface. Note that lens group indicates a portion including at least one lens separated by an air distance that changes upon zooming.

The zoom optical system of each embodiment is not limited to including the first to third focus lens groups described above, a single or a plurality of lens groups, or a partial lens groups may serve as a focus lens group that is moved in the optical axis direction and perform focusing from the infinity object to the short-distance object. The focus lens group can also be applied to autofocus, and is also suited to autofocus motor driving (using an ultrasonic motor or the like).

A lens group or a partial lens group may serve as a vibration-proof lens group that is moved so as to have a movement component in a direction perpendicular to the optical axis or moved rotationally (swung) in a direction in a plane including the optical axis to reduce image blur caused by camera shake.

Each lens surface may be formed as a spherical surface, a planar surface, or an aspherical surface. The lens surface is preferably a spherical surface or a planar surface, because this facilitates lens processing and assembly adjustment, and deterioration in optical performance due to errors in the processing and the assembly adjustment can be prevented. This is also preferable, because there is only little deterioration in depiction performance even when the image surface is displaced.

When the lens surface is aspherical, the aspherical surface may be any of an aspherical surface obtained by grinding, a molded glass aspherical surface obtained by forming glass into an aspherical shape using a mold, or a composite type aspherical surface obtained by forming a resin into an aspherical shape on the surface of glass. The lens surface may also be a diffractive surface, and the lens may also be a gradient index lens (GRIN lens) or a plastic lens.

The aperture stop is preferably arranged between the third lens group and the fourth lens group, but a lens frame may be adapted to serve as an aperture stop without providing an actual member of an aperture stop.

In order to achieve high-contrast optical performance with reduced flaring and ghosting, an anti-reflective coating having high transmittance over a wide wavelength range may also be applied to each lens surface.

### EXPLANATION OF NUMERALS AND CHARACTERS

G1: first lens group
G2: second lens group
G3: third lens group
G4: fourth lens group
G5: fifth lens group
G6: sixth lens group
G7: seventh lens group
G8: eighth lens group
G9: ninth lens group
I: image surface
S: aperture stop

1. A zoom optical system comprising:
in order from an object along an optical axis, a first lens group having positive refractive power, a second lens group having negative refractive power, a third lens group having positive refractive power, and a rear group, wherein
when zooming from a wide-angle end state to a first telephoto end state, a distance between each adjacent lens group changes, the first lens group is fixed relative to an image surface, and N1 lens groups move along the optical axis,
when zooming from the first telephoto end state to a second telephoto end state, the first lens group is fixed relative to the image surface, and N2 lens groups move along the optical axis,
N1 is an integer of 3 or higher and N2 is a positive integer lower than N1, and
the following conditional expressions are satisfied-:
0.10<MB/MA<2.00
ft1/ft2<0.95
Where MA: a movement amount of a lens group with the largest movement amount when zooming from the wide-angle end state to the first telephoto end state,
MB: a movement amount of the lens group with the largest movement amount when zooming from the first telephoto end state to the second telephoto end state,
ft1: a focal length of the zoom optical system in the first telephoto end state, and
ft2: a focal length of the zoom optical system in the second telephoto end state.

2. A zoom optical system comprising:
in order from an object along an optical axis, a first lens group having positive refractive power, a second lens group having negative refractive power, a third lens group having positive refractive power, and a rear group, wherein
when zooming from a wide-angle end state to a first telephoto end state, a distance between each adjacent lens group changes, the first lens group is fixed relative to an image surface, and the second lens group moves along the optical axis,
when zooming from the first telephoto end state to a second telephoto end state, the first lens group and the second lens group are fixed relative to the image surface, and at least part of the rear group moves along the optical axis, and
the following conditional expressions are satisfied:
0.75<MG2/(−f2)<1.30
ft1/ft2<0.95
Where f2: a focal length of the second lens group,
MG2: a movement amount of the second lens group when zooming from the wide-angle end state to the first telephoto end state,
ft1: a focal length of the zoom optical system in the first telephoto end state, and
ft2: a focal length of the zoom optical system in the second telephoto end state.

3. The zoom optical system according to claim 1, wherein
the rear group includes the N2 focus lens groups that move along the optical axis when focusing,
N2 is an integer of 2 or higher and lower than N1, and
when zooming from the first telephoto end state to the second telephoto end state, the N2 focus lens groups move along the optical axis.

4. The zoom optical system according to claim 2, wherein
the rear group includes at least two focus lens groups that move along the optical axis when focusing, and
when zooming from the first telephoto end state to the second telephoto end state, the at least two focus lens groups move along the optical axis.

5. The zoom optical system according to claim 1, wherein the following conditional expression is satisfied:
0.01<Bft2/ft2<0.30
Where Bft2: a back focus of the zoom optical system in the second telephoto end state.

6. The zoom optical system according to claim 1, wherein
the rear group includes a final lens group arranged closest to the image surface, and
when zooming from the wide-angle end state and the first telephoto end state and when zooming from the first telephoto end state to the second telephoto end state, the final lens group is fixed relative to the image surface.

7. The zoom optical system according to claim 1, wherein when zooming from the first telephoto end state to the second telephoto end state, the third lens group is fixed relative to the image surface.

8. The zoom optical system according to claim 1, wherein the following conditional expression is satisfied:
0.75<D23/(−f2)<1.40
Where f2: the focal length of the second lens group, and
D23: a change amount of a distance on the optical axis between the second lens group and the third lens group when zooming from the wide-angle end state to the first telephoto end state.

9. The zoom optical system according to claim 1, wherein the following conditional expression is satisfied:
0.45<D23/f3<1.00
Where f3: a focal length of the third lens group, and
D23: the change amount of the distance on the optical axis between the second lens group and the third lens group when zooming from the wide-angle end state to the first telephoto end state.

10. The zoom optical system according to claim 1, wherein
the rear group includes at least two focus lens groups that move along the optical axis when focusing, and
the following conditional expression is satisfied:
0<MF1w/MF1t<1.00
Where MF1w: a movement amount of a first focus lens group arranged closest to the object among the at least two focus lens groups, when zooming from the wide-angle end state to the first telephoto end state, and
MF1t: a movement amount of the first focus lens group when zooming from the first telephoto end state to the second telephoto end state.

11. The zoom optical system according to claim 1, wherein
the rear group includes at least two focus lens groups that move along the optical axis when focusing, and
the following conditional expression is satisfied:
0.05<MF2w/MF2t<10.00
Where MF2w: a movement amount of a second focus lens group arranged second closest to the object among the at least two focus lens groups, when zooming from the wide-angle end state to the first telephoto end state, and
MF2t: a movement amount of the second focus lens group when zooming from the first telephoto end state to the second telephoto end state.

12. The zoom optical system according to claim 1, wherein the following conditional expression is satisfied:
0.01<MC/MB<2.00
Where MB: the movement amount of a lens group with the largest movement amount when zooming from the first telephoto end state to the second telephoto end state, and
MC: a movement amount of a lens group with the smallest movement amount when zooming from the first telephoto end state to the second telephoto end state.

13. The zoom optical system according to claim 1, wherein the following conditional expression is satisfied:
0.10<Bft2/MB<5.00
Where MB: the movement amount of the lens group with the largest movement amount when zooming from the first telephoto end state to the second telephoto end state, and
Where Bft2: a back focus of the zoom optical system in the second telephoto end state.

14. The zoom optical system according to claim 1, wherein the following conditional expression is satisfied:
0.05<(−f2)/f1<1.00
Where f1: a focal length of the first lens group, and
f2: the focal length of the second lens group.

15. The zoom optical system according to claim 1, wherein the following conditional expression is satisfied:
0.01<Bfw/fw<0.50
Where fw: a focal length of the zoom optical system in the wide-angle end state, and
Bfw: a back focus of the zoom optical system in the wide-angle end state.

16. The zoom optical system according to claim 1, wherein the following conditional expression is satisfied:
2.00<TLw/fw<6.00
Where fw: the focal length of the zoom optical system in the wide-angle end state, and
TLw: an entire length of the zoom optical system in the wide-angle end state.

17. The zoom optical system according to claim 1, wherein the following conditional expression is satisfied:
0.01<(−f2)/f3<2.00
Where f2: the focal length of the second lens group, and
f3: the focal length of the third lens group.

18. The zoom optical system according to claim 1, wherein the following conditional expression is satisfied:
1.80<f1/f3<2.50
Where f1: the focal length of the first lens group, and
f3: the focal length of the third lens group.

19. The zoom optical system according to claim 1, wherein
the rear group includes a final lens group arranged closest to the image surface, and
the following conditional expression is satisfied:
0.01<|fr1/fr|<5.00
Where fr: a focal length of the final lens group, and
fr1: a focal length of a lens group arranged in order from the object of the final lens group in the rear group.

20. The zoom optical system according to claim 1, wherein
the rear group includes a final lens group arranged closest to the image surface, and
the following conditional expression is satisfied:
0.10<f2/fr1<0.75
Where f2: the focal length of the second lens group, and
fr1: the focal length of the lens group arranged in order from the object of the final lens group in the rear group.

21. An optical device comprising the zoom optical system according to claim 1.

22. A method of manufacturing a zoom optical system comprising, in order from an object along an optical axis, a first lens group having positive refractive power, a second lens group having negative refractive power, a third lens group having positive refractive power, and a rear group,
the method of manufacturing the zoom optical system comprises the following feature A or B, wherein
the feature A comprises:
when zooming from a wide-angle end state to a first telephoto end state, a distance between each adjacent lens group changes, the first lens group is fixed relative to an image surface, and N1 lens groups move along the optical axis,
when zooming from the first telephoto end state to a second telephoto end state, the first lens group is fixed relative to the image surface, and N2 lens groups move along the optical axis,
N1 is an integer of 3 or higher and N2 is a positive integer lower than N1, and
the method of manufacturing the zoom optical system comprises arranging each lens in a lens barrel so that the following conditional expressions are satisfied:
0.10<MB/MA<2.00
ft1/ft2<0.95
Where MA: a movement amount of a lens group with the largest movement amount when zooming from the wide-angle end state to the first telephoto end state,
MB: a movement amount of the lens group with the largest movement amount when zooming from the first telephoto end state to the second telephoto end state,
ft1: a focal length of the zoom optical system in the first telephoto end state, and
ft2: a focal length of the zoom optical system in the second telephoto end state, and
the feature B comprises:
when zooming from a wide-angle end state to a first telephoto end state, a distance between each adjacent lens group changes, the first lens group is fixed relative to an image surface, and the second lens group moves along the optical axis,
when zooming from the first telephoto end state to a second telephoto end state, the first lens group and the second lens group are fixed relative to the image surface, and at least part of the rear group moves along the optical axis, and
the method of manufacturing the zoom optical system comprises arranging each lens in a lens barrel so that the following conditional expressions are satisfied:
0.75<MG2/(−f2)<1.30
ft1/ft2<0.95
Where f2: a focal length of the second lens group,
MG2: a movement amount of the second lens group when zooming from the wide-angle end state to the first telephoto end state,
ft1: a focal length of the zoom optical system in the first telephoto end state, and
ft2: a focal length of the zoom optical system in the second telephoto end state.

23. (canceled)

24. A zoom optical system comprising:
a lens group for zooming that moves in an optical axis direction when zooming from a wide-angle end state to a first telephoto end state; and
a lens group for focusing that moves in the optical axis direction when zooming from the wide-angle end state to the first telephoto end state and moves in the optical axis direction for focusing, wherein
the lens group for focusing is moved in the optical axis direction and the first telephoto end state is switched to a second telephoto end state having a higher magnification, while the lens group for zooming remains fixed in the optical axis direction.

25. The optical system according to claim 24, comprises:
a cam mechanism for continuously moving the lens group for zooming along an optical axis in accordance with zooming from the wide-angle end state to the first telephoto end state; and
a motor moving the lens group for focusing along the optical axis, wherein
the motor is drive-controlled when switching from the first telephoto end state to the second telephoto end state so that a desired zoom state is achieved in at least in the first telephoto end state and the second telephoto end state.

26. The zoom optical system according to claim 2, wherein the following conditional expression is satisfied:
0.01<Bft2/ft2<0.30
Where Bft2: a back focus of the zoom optical system in the second telephoto end state.

27. The zoom optical system according to claim 2, wherein
the rear group includes a final lens group arranged closest to the image surface, and
when zooming from the wide-angle end state and the first telephoto end state and when zooming from the first telephoto end state to the second telephoto end state, the final lens group is fixed relative to the image surface.

28. The zoom optical system according to claim 2, wherein when zooming from the first telephoto end state to the second telephoto end state, the third lens group is fixed relative to the image surface.

29. The zoom optical system according to claim 2, wherein the following conditional expression is satisfied:
0.75<D23/(−f2)<1.40
Where f2: the focal length of the second lens group, and
D23: a change amount of a distance on the optical axis between the second lens group and the third lens group when zooming from the wide-angle end state to the first telephoto end state.

30. The zoom optical system according to claim 2, wherein the following conditional expression is satisfied:
0.45<D23/f3<1.00
Where f3: a focal length of the third lens group, and
D23: the change amount of the distance on the optical axis between the second lens group and the third lens group when zooming from the wide-angle end state to the first telephoto end state.

31. The zoom optical system according to claim 2, wherein
the rear group includes at least two focus lens groups that move along the optical axis when focusing, and
the following conditional expression is satisfied:
0<MF1w/MF1t<1.00
Where MF1w: a movement amount of a first focus lens group arranged closest to the object among the at least two focus lens groups, when zooming from the wide-angle end state to the first telephoto end state, and
MF1t: a movement amount of the first focus lens group when zooming from the first telephoto end state to the second telephoto end state.

32. The zoom optical system according to claim 2, wherein
the rear group includes at least two focus lens groups that move along the optical axis when focusing, and
the following conditional expression is satisfied:
0.05<MF2w/MF2t<10.00
Where MF2w: a movement amount of a second focus lens group arranged second closest to the object among the at least two focus lens groups, when zooming from the wide-angle end state to the first telephoto end state, and
MF2t: a movement amount of the second focus lens group when zooming from the first telephoto end state to the second telephoto end state.

33. The zoom optical system according to claim 2, wherein the following conditional expression is satisfied:
0.01<MC/MB<2.00
Where MB: the movement amount of a lens group with the largest movement amount when zooming from the first telephoto end state to the second telephoto end state, and
MC: a movement amount of a lens group with the smallest movement amount when zooming from the first telephoto end state to the second telephoto end state.

34. The zoom optical system according to claim 2, wherein the following conditional expression is satisfied:
0.10<Bft2/MB<5.00
Where MB: the movement amount of the lens group with the largest movement amount when zooming from the first telephoto end state to the second telephoto end state, and
Where Bft2: a back focus of the zoom optical system in the second telephoto end state.

35. The zoom optical system according to claim 2, wherein the following conditional expression is satisfied:
0.05<(−f2)/f1<1.00
Where f1: a focal length of the first lens group, and
f2: the focal length of the second lens group.

36. The zoom optical system according to claim 2, wherein the following conditional expression is satisfied:
0.01<Bfw/fw<0.50
Where fw: a focal length of the zoom optical system in the wide-angle end state, and
Bfw: a back focus of the zoom optical system in the wide-angle end state.

37. The zoom optical system according to claim 2, wherein the following conditional expression is satisfied:
2.00<TLw/fw<6.00
Where fw: the focal length of the zoom optical system in the wide-angle end state, and
TLw: an entire length of the zoom optical system in the wide-angle end state.

38. The zoom optical system according to claim 2, wherein the following conditional expression is satisfied:
0.01<(−f2)/f3<2.00
Where f2: the focal length of the second lens group, and
f3: the focal length of the third lens group.

39. The zoom optical system according to claim 2, wherein the following conditional expression is satisfied:
1.80<f1/f3<2.50
Where f1: the focal length of the first lens group, and
f3: the focal length of the third lens group.

40. The zoom optical system according to claim 2, wherein
the rear group includes a final lens group arranged closest to the image surface, and
the following conditional expression is satisfied:
0.01<|fr1/fr|<5.00
Where fr: a focal length of the final lens group, and
fr1: a focal length of a lens group arranged in order from the object of the final lens group in the rear group.

41. The zoom optical system according to claim 2, wherein
the rear group includes a final lens group arranged closest to the image surface, and
the following conditional expression is satisfied:
0.10<f2/fr1<0.75
Where f2: the focal length of the second lens group, and
fr1: the focal length of the lens group arranged in order from the object of the final lens group in the rear group.

42. An optical device comprising the zoom optical system according to claim 2.
